(19) United States
(12) Patent Application Publication
(10) Pub. No.: US 2023/0171795 A1
(43) Pub. Date: Jun. 1, 2023

(54) SIDELINK ENHANCEMENTS - RESOURCE ALLOCATION SIMULTANEOUS MODE 1/MODE 2

(71) Applicant: INTERDIGITAL PATENT HOLDINGS, INC., Wilmington, DE (US)

(72) Inventors: Rocco DI GIROLAMO, Laval, CA (US); Pascal ADJAKPLE, Great Neck, NY (US); Mohamed M. AWADIN, Plymouth Meeting, PA (US); Qing LI, Princeton Junction, NJ (US); Yifan LI, Conshohocken, PA (US); Kyle PAN, Saint James, NY (US); Zhuo CHEN, Claymont, DE (US); Allan TSAI, Boonton, NJ (US)

(21) Appl. No.: 17/995,724

(22) PCT Filed: Apr. 8, 2021
(86) PCT No.: PCT/US2021/026337

§ 371 Date: Oct. 7, 2022

Related U.S. Application Data
(60) Provisional application No. 63/007,174, filed on Apr. 8, 2020.

(51) Int. Cl. H04W 72/40; H04W 72/23; H04W 72/02; H04W 72/51

(52) U.S. Cl. CPC H04W 72/40; H04W 72/23; H04W 72/02; H04W 72/51

(57) ABSTRACT

A wireless User Equipment (UE) may indicate to a base station (gNB) that the UE is capable of simultaneously using sidelink resource allocations Mode 1, with scheduling by the gNB, and sidelink resource allocation Mode 2 with scheduling by the UE, and then receive from the gNB, a Medium Access Control (MAC) entity configuration comprising information for Mode 1 and for Mode 2, and Sidelink Radio Bearer (SERB) configurations which may include the mode (Mode 1 or Mode 2) for the SERB. The UE may determine grants for both modes. In case of a grant collision or overlap, the UE may use logical channel priority to select one grant over the other. The UE may change from one mode to another. The MAC entity may take actions related to feedback, BSR reporting, and SR reporting, to manage the transitions.

### CROSS-REFERENCE TO RELATED APPLICATIONS

This application claims the benefit of U.S. Provisional Patent Application No. 63/007,174, filed 8 Apr. 2020, the contents of which is hereby incorporated by reference in its entirety.

### BACKGROUND

This disclosure pertains to the management of wireless devices in cellular, machine-to-machine, and other networks, such as those described in, for example: 3GPP TS 38.331, NR: Radio Resource Control (RRC) protocol specification, V15.8.0; 3GPP TS 38.321, NR; Medium Access Control (MAC) protocol specification, V15.8.0; R2-2001969 CR 38.321: Introduction of 5G V2X with NR sidelink; R2-2001966 CR 38.331: Introduction of 5G V2X with NR sidelink; and R2-2002264 CR 38.300: Introduction of 5G V2X with NR sidelink.

### SUMMARY

Mode 2 resource allocation is a distributed mechanism which relies on sensing to determine when a UE may transmit on the sidelink. It suffers from a number of drawbacks such as: power inefficiency, unused sidelink resources, and potential sidelink traffic collisions (for example resulting from hidden nodes).

Simultaneous Mode 1/Mode2 resource allocation allows a UE with multiple SLRBs with different QoS requirements, to better match these requirements to the resource allocation mode. A UE may be configured to use simultaneous Mode 1 and Mode 2 resource allocations. The UE may be adapted to select a resource allocation mode for a SLRB, and to change resource allocation mode. A MAC entity may be allowed to manage grants for both Mode 1 and Mode 2, and to accommodate switching between modes. UEs may be also adapted to deal with potential grant collisions and grant overlaps, e.g., by using priority information.

For example, a UE may be adapted to send to a gNB a capability indication signifying the UEs ability to simultaneously use Mode 1 and Mode 2 resource allocation, and then receive MAC entity configurations for both resource allocation modes, and also receive an SLRB configuration that includes the resource allocation mode for the SLRB.

A UE capable of simultaneous transmission of PUSCH, and one or more PSSCHs over the same slot, may be adapted to determine the power for a channel based on the priority of the logical channel and the power remaining after allocating the power for any higher priority logical channels.

A MAC layer may be adapted to determine a first configured sidelink grant if more than one SLRB is configured as Mode 1, and then tag the first configured sidelink grant with a type of Mode 1. Similarly, the MAC layer may determine a second configured sidelink grant if more than one SLRB is configured as Mode 2, and then tag the second configured sidelink grant as being of type Mode 2.

The MAC layer may then send the configured sidelink grants, having the tagged type, to a HARQ entity, and/or build the MAC PDU for the configured sidelink grants using logical channel restrictions. The MAC layer may ask the physical layer to signal the acknowledgement to the gNB if sidelink PUCCH is configured and the sidelink feedback received was for a MAC PDU transmitted using a configured sidelink grant tagged as being of type

### Mode 1.

The determination of the second configured sidelink grant is based on SLRBs configured for Mode 2, for example. The logical channel restrictions ensure that only logical channels configured as Mode 1 are included in the MAC PDU using the first configured sidelink grant, and the logical channel restrictions ensure that only logical channels configured as Mode 2 are included in the MAC PDU using the second configured sidelink grant.

A UE that has collided Mode 1 and Mode 2 grants or overlapping Mode 1 and Mode 2 grants may select the grant to use in a slot and notify the gNB if a Mode 2 grant was selected over a Mode 1 grant. The selection of the grant is based on: absolute priorities of the logical channels; relative priorities of the sidelink transmissions; grant priority signaled in the Mode 1 grant and compared with a configured Mode 2 grant priority; destination of the grant; the size of the grant.

A UE configured for Mode 1 resource allocation may be adapted to receive a configuration for Mode 1 sensing at the physical layer to determine the candidate resource set, perform the sensing based on the configuration, and send a measurement report to the gNB with the sensed information. The UE may then receive a scheduled grant that excludes those resources that were sensed as containing potential Mode 2 transmissions from other UEs. If the UE supports simultaneous Mode 1 and Mode 2, the measurement report may contain the actual configured sidelink grant to be used by the Mode 2 transmissions of the UE.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to limitations that solve any or all disadvantages noted in any part of this disclosure.

### BRIEF DESCRIPTION OF THE DRAWINGS

A more detailed understanding may be had from the following description, given by way of example in conjunction with the accompanying drawings.

FIG. 1 illustrates an example of resource allocation for in coverage and out-of-coverage UEs.

FIG. 2 illustrates an example of resource allocation with assistance information.

FIGS. 3A-3E illustrate an example of sidelink deployments.

FIG. 4 illustrates an example of mode 1/mode 2 sidelink resource allocation.

FIG. 5 illustrates a first example of MAC architecture.

FIG. 6 illustrates a second example of MAC architecture.

FIG. 7 illustrates a third example of MAC architecture.

FIGS. 8A-8C illustrate an example of Tx resource pools.

FIG. 9 illustrates an example of UE with multiple SLRBS using different resource allocation modes.

FIG. 10 illustrates an example of power control for UEs with simultaneous PUSCH/PSCCHS.

FIG. 11 illustrates an example of modified sidelink grant determination procedure.

FIGS. 12A-12C illustrate an example of modified HARQ entity process.

FIG. 13 illustrates an example of modified sidelink feedback process.

FIG. 14 illustrates an example of transport blocks with different aggregate priority.

FIG. 15 illustrates an example of avoiding grant overlap/grant collision.

FIG. 16A illustrates an example communications system in which the methods and apparatuses described and claimed herein may be embodied.

FIG. 16B is a block diagram of an example apparatus or device configured for wireless communications.

FIG. 16C is a system diagram of an example radio access network (RAN) and core network.

FIG. 16D is a system diagram of another example RAN and core network.

FIG. 16E is a system diagram of another example RAN and core network.

FIG. 16F is a block diagram of an example computing system.

FIG. 16G is a block diagram of another example communications system.

### DETAILED DESCRIPTION

Table 1 describes some of the abbreviations used herein.

TABLE 1
Abbreviations

| | |
|---|---|
| BSR | Buffer Status Reporting |
| CSI | Channel State Information |
| DCI | Downlink Control Information |
| gNB | NR NodeB |
| HARQ | Hybrid Automatic Repeat Request |
| IC | In Coverage |
| LCP | Logical Channel Prioritization |
| MAC | Media Access Control |
| NAS | Non-Access Stratum |
| NG-RAN | NG-Radio Access Network |
| NR | New Radio |
| OOC | Out of Coverage |
| PDCCH | Physical Dedicated Control Channel |
| PDU | Protocol Data Unit |
| PHY | Physical |
| PHR | Power Headroom |
| PIR | Packet Inter-Reception |
| PLMN | Public Land Mobile Network |
| PRR | Packet Reception Ratio |
| PSCCH | Physical Sidelink Control Channel |
| PSFCH | Physical Sidelink Feedback Channel |
| PSSCH | Physical Sidelink Shared Channel |
| PUSCH | Physical Uplink Shared Channel |
| RAN | Radio Access Network |
| QoS | Quality of Service |
| RNTI | Radio Network Temporary Identifier |
| RRC | Radio Resource Control |
| RSRP | Reference Signal Receive Power |
| RX or Rx | Receive |
| SCI | Sidelink Control Information |
| SINR | Signal-to-noise-plus-interference ratio |
| SL | Sidelink |
| SL-BCH | Sidelink Broadcast Channel |
| SL SCH | Sidelink Shared Channel |
| SLCS | Sidelink Configured Scheduling |
| SLRB | Sidelink Radio Bearer |
| SR | Scheduling Request |
| TX or Tx | Transmit |
| UCI | Uplink Control Information |
| UE | User Equipment |

Sidelink Resource Allocation

Sidelink resource allocation refers to the process by which a UE determines the resources to use for sidelink transmission. 5G NR supports 2 basic modes of Resource allocation. In Mode 1 (network controlled), a base station schedules sidelink resource(s) to be used by UE for sidelink transmission(s). The UE has to be in RRC_CONNECTED and UE has to be in coverage. In Mode 2 (UE autonomous), the UE makes the determination. The base station does not schedule. Sidelink transmission resource(s) are within sidelink resources configured by base station/network or pre-configured in the UE. The UE may be in RRC_CONNECTED, RRC_IDLE, or RRC_INACTIVE and UE may be in-coverage or out-of-coverage

The resources are selected from Tx resource pools. This is in line with resource allocation modes defined for LTE D2D and LTE V2X

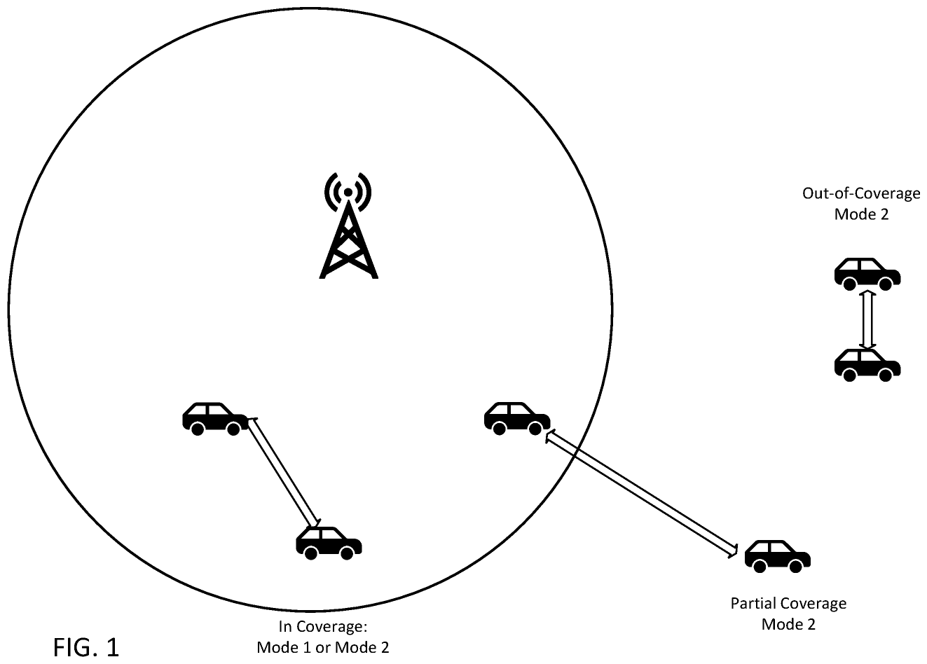

FIG. 1 illustrates and example of resource allocation for in coverage and out-of-coverage UEs.

Release 17 Work Item

Release 17 has started an activity to enhance the Mode 2 Resource allocation. One of the objectives was to study the feasibility and benefit of the enhancement(s) in mode 2 for enhanced reliability and reduced latency in consideration of both Packet Reception Ratio (PRR) and Packet Inter-Reception (PIR) and to specify the identified solution if deemed feasible and beneficial. PRR is a measure of reliability and is calculated by determining the number of UEs receiving a packet in Range A divided by the number of UEs in a Range A. PIR is a measure of latency, defined as the time between successive successful receptions of 2 different packets. Inter-UE coordination was considered a priority. In inter-UE coordination, a set of resources is determined at UE-A. This set is sent to UE-B in mode 2, and UE-B takes this into account in the resource selection for its own transmission.

Note that the standardization bodies did leave open the possibility of more enhancements to resource allocation.

The solution should be able to operate in-coverage, partial coverage, and out-of-coverage and to address consecutive packet loss in all coverage scenarios.

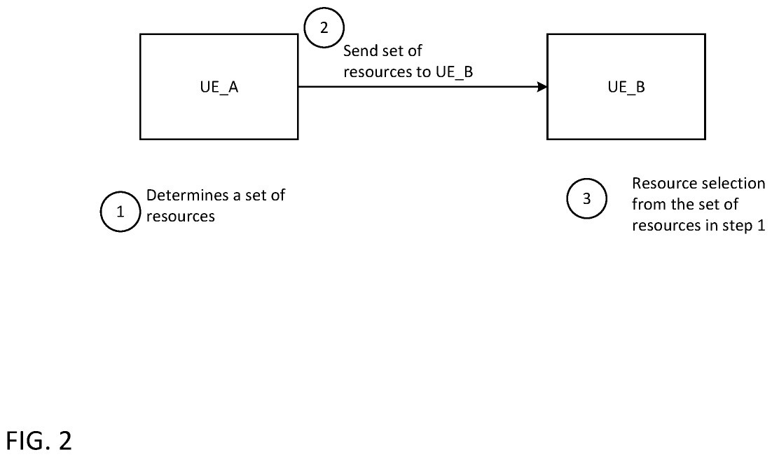

The goals of the enhanced resource allocation, as illustrated in the example of FIG. 2, are: to reduce power consumption at UE_B; to make sidelink communication from UE_B reliable; and to make sure sidelink communication from UE_B has short latency.

Example Challenges

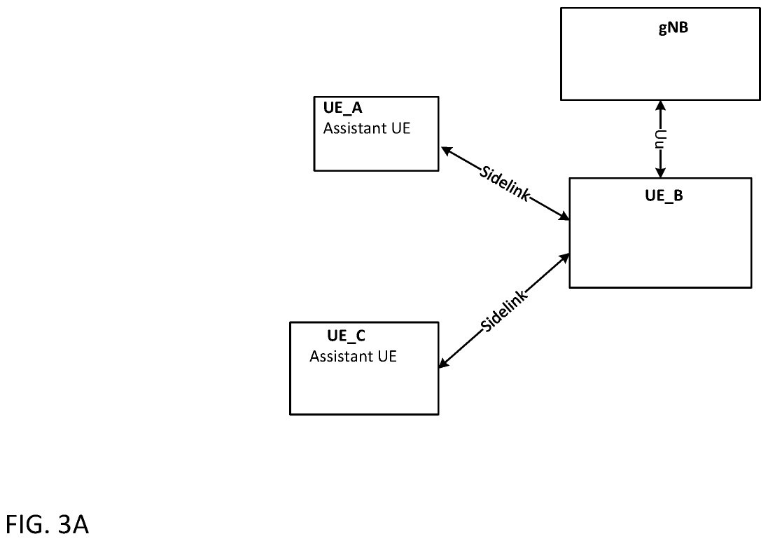

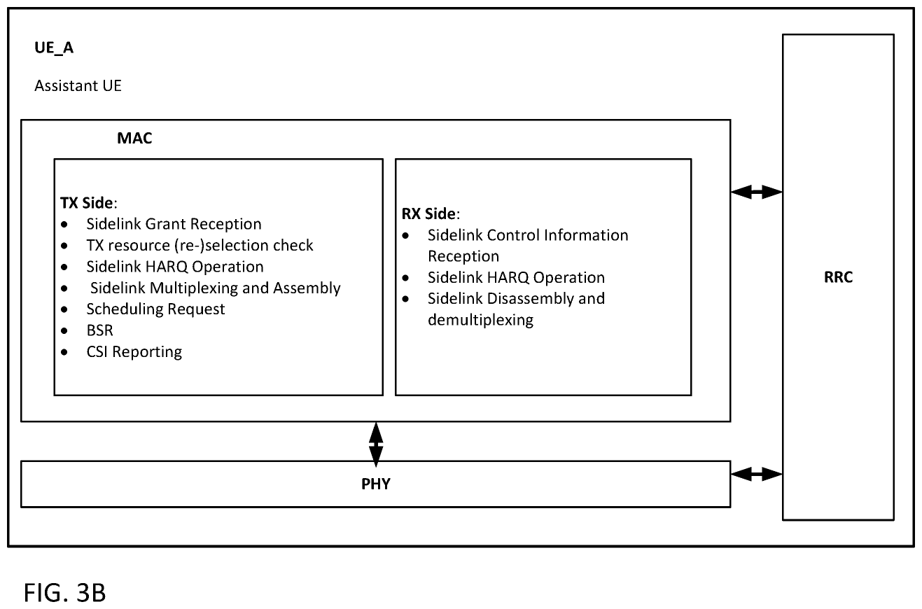

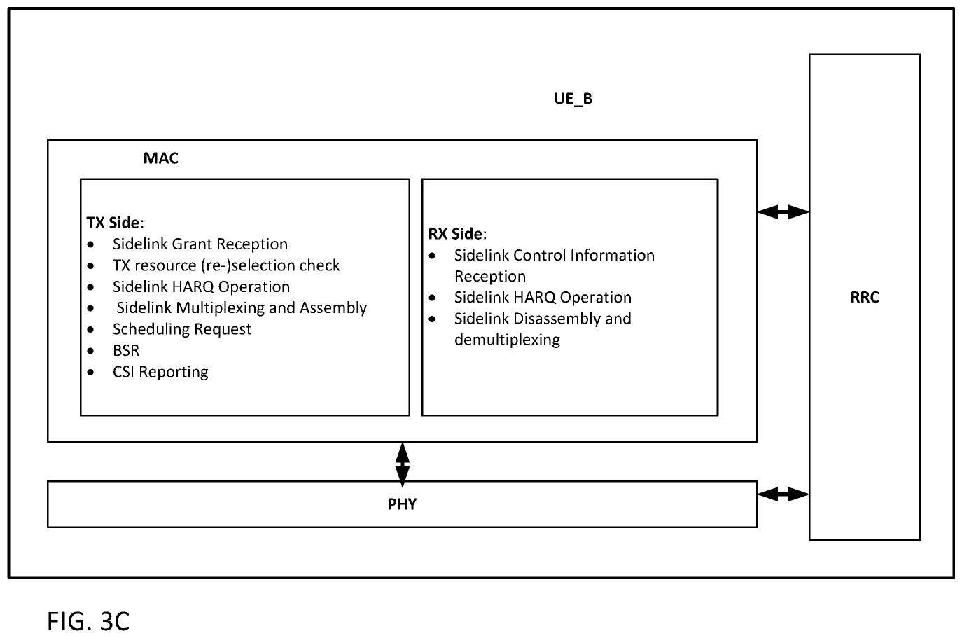

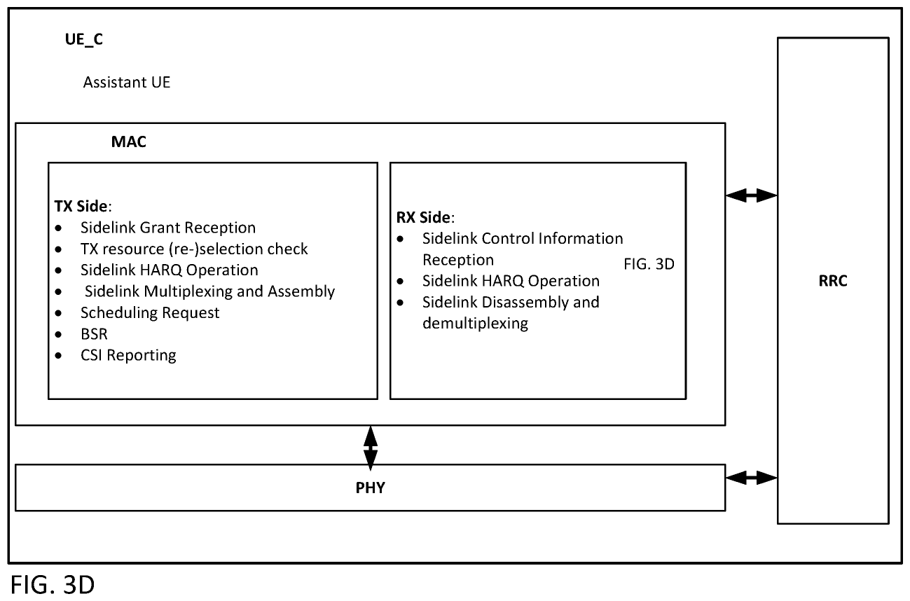

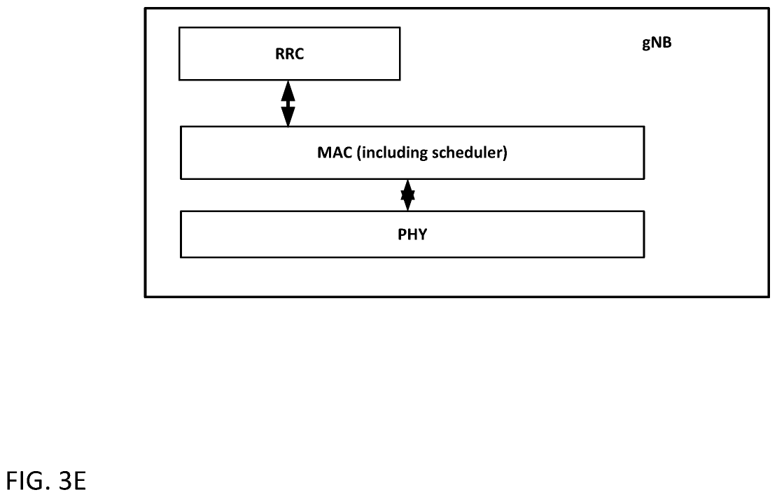

The proposed Release 17 enhancements to sidelink will permit deployments as shown in FIGS. 3A-3E. In FIG. 3A, a UE (UE_B) is served by a serving cell and has a Uu connection to a gNB. UE_B may use Mode 1 or Mode 2 resource allocation mode, and may dynamically and semi-statically change from one resource allocation mode to another. Furthermore, when in Mode 2, UE_B may receive scheduling assistance from one or more Assistant UEs (UE_A and UE_C). Example interior features of UE_A, UE_B, UE_C, and the gNB are illustrated in FIGS. 3B, 3C, 3D, and 3E, respectively.

The Medium Access Control (MAC) layer is responsible for data transfer on the sidelink Scheduled Channel (SL-SCH). It has a number of sub-processes/functions for transmission. Each of these sub-processes/functions is described with a dedicated section (shown in parenthesis) of the 3GPP TS 38.321, NR: Medium Access Control (MAC) protocol specification, V15.8.0:

Sidelink Grant Reception (5.x.1.1)

TX resource (re-)selection check (5.x.1.2)

Sidelink HARQ Operation (5.x.1.3)

Sidelink Multiplexing and Assembly (5.x.1.4)

Scheduling Request (5.x.1.5)

Buffer Status Reporting (BSR) (5.x.1.6)

Channel State Information (CSI) Reporting (5.x.1.7)

In addition, the MAC layer has a number of sub-processes/functions for reception:

Sidelink Control Information Reception (5.x.2.1)

Sidelink HARQ Operation (5.x.2.2)

Sidelink Disassembly and demultiplexing (5.x.2.3)

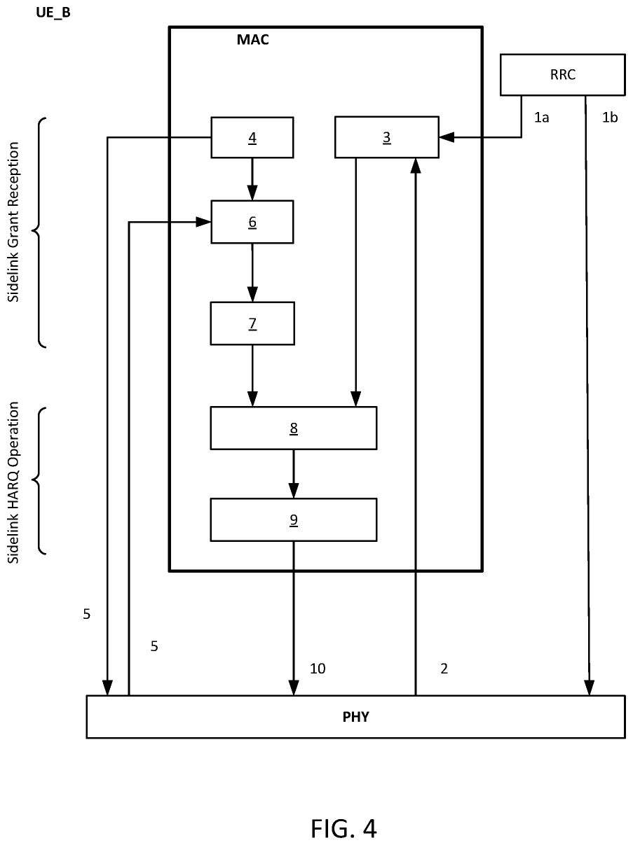

The proposed sidelink enhancements will have an impact in the legacy (Release 16) sidelink resource allocation process. The basic process is shown in FIG. 4 and described below:

Step 1a: The RRC configures the MAC entity for sidelink operation. This includes if the MAC entity is to use resource allocation Mode 1 (either dynamic grants or configured grants) or resource allocation Mode 2 (either sensing based on random access based). The random access based is targeting exception resource pools.

Step 1b: The RRC configures the PHY entity for sidelink operation. This includes the Tx resource pool configuration, as well as Mode 1 configuration, and Mode 2 configuration. For the latter, the RRC may include the sensing configuration.

Step 2: The PHY informs the MAC layer when it receives DCI in the PDCCH occasion.

The Sidelink Grant Reception determines the sidelink grant for UE_B. At the MAC layer, the transmission opportunities for these sidelink grants are referred to as PSCCH/PSSCH durations.

If configured for Mode 1 Operation, then in Step 3: The Sidelink Grant Reception determines if the PDCCH occasion has a sidelink grant. This is determined if the DCI is destined for SL-RNTI or SLCS-RNTI. The former is used for dynamic grants, while the latter is used for configured grant Type 2—namely activation, deactivation, or to schedule a retransmission for a Configured grant transmission

Steps 4, 5, and 6 address Mode 2 Operation. If configured for Mode 2 Operation, then in Step 4, the transmitting UE needs to continually evaluate which PSCCH/PSSCH durations may be used for a single MAC PDU transmission, for multiple MAC PDU transmissions, and the potential retransmissions of these MAC PDUs. To accomplish this, the Sidelink Grant Reception continually evaluates if Tx resource (re)selection is necessary. Many triggers can tell the MAC layer that it needs to find new PSCCH/PSSCH durations. For example, there is a reconfiguration of the Tx resource pools, there is new traffic that has no opportunity to be transmitted on sidelink, the PSCCH/PSSCH durations have not been used for an extended period of time, etc.

Step 5: In order to assist the Sidelink Grant Reception, the MAC layer asks the PHY layer to provide a set of potential resources. These are provided by the PHY layer (either based on sensing, or based on the configured exception resource pool). This is referred to as the Candidate Resource set.

Step 6: The Sidelink Grant Reception randomly selects from this provided set of potential resources—in order to satisfy the transmission of one MAC PDU, multiple MAC PDUs, and the potential retransmissions of these MAC PDUs. The selected set denote the PSCCH/PSSCH durations for transmission.

Step 7: At the PSCCH/PSSCH duration, the Sidelink Grant Reception selects the MCS for the sidelink grant, and then sends the sidelink grant, the selected MCS, and the associated HARQ information to the Sidelink HARQ Entity for this PSSCH duration.

Step 8: The Sidelink HARQ entity, obtains the MAC PDU from Multiplexing and Assembly process. This is where Logical Channel Prioritization (LCP) occurs. The Sidelink HARQ entity, also determines the sidelink control information for MAC PDU, and then delivers the MAC PDU, the sidelink grant and the Sidelink transmission information to the associated Sidelink process

Step 9-10: The Sidelink Process, at appropriate PSCCH/PSSCH duration, tells the PHY to transmit SCI, then tells the PHY to generate a transport block transmission. If HARQ is enabled, Sidelink Process also tells the PHY to monitor PSFCH

Issue: Simultaneous Mode 1 and Mode 2 Resource Allocation

An issue arises for simultaneous Mode 1 and Mode 2 resource allocation. A UE may operate with multiple sidelinks and (1) simultaneously use Mode 1 and Mode 2 resource allocation, and (2) semi-statically or dynamically change between Mode 1 and Mode 2 resource allocation. Note that as the UE relies on network-controlled resource allocation (for Mode 1), Simultaneous Mode 1 and Mode 2 Resource Allocation assumes that the UE is in-coverage. A number of problems need to be addressed for this issue.

Problem 1: UE Dynamically Selecting Between Mode 1 and Mode 2

A first problem pertains to a UE dynamically selecting between Mode 1 and Mode 2. Traffic from a Sidelink flow needs to be transmitted using either Mode 1 or Mode 2 resource allocation. For Release 16, for in-coverage UEs, this decision is made by the gNB and configured through RRC signaling. This is a property of the MAC entity. Changing the resource allocation mode is possible, but this requires an RRC reconfiguration of the MAC entity. To better match the various QoS requirements of the sidelink traffic, as well as the changing radio conditions, the resource allocation mode may be changed semi-statically or dynamically for a specific sidelink traffic flow. In such a case, the MAC entity would need new functionality to semi-statically or dynamically determine when to use Mode 1 or Mode 2 resource allocation. When new sidelink data becomes available to the MAC entity, the MAC entity has to determine whether to transmit this sidelink data through Mode 1 SR/BSR mechanism or through Mode 2 autonomous mechanism. This may depend on a number of factors such as: availability of Uu, radio conditions, load, etc. The MAC entity would also need to know when to make this determination. For example, this determination can be made periodically or when some event occurs.

Problem 2: UE MAC Procedure Maintenance Upon Change of Resource Allocation Mode

A second problem arises when a sidelink flow changes from resource allocation mode 1 to resource allocation mode 2 (or vice versa), the MAC entity may be running one or more associated MAC procedures. Examples include SR, BSR, & PHR for resource allocation mode 1, and sensing for resource allocation mode 2. These procedures have a certain state. Upon a change of resource allocation mode, some of these procedures will need to be terminated, and the state related to these procedures cleared. In addition, for transition out of Resource Allocation Mode 1, the gNB may not be aware of the transition. This may lead to some inefficiencies.

When dynamically or semi-statically transitioning from Mode 1 to Mode 2, both the BSR and SR mechanism are impacted. For SL-BSR, the MAC entity may trigger a SL-BSR, and it maintains timers: periodicBSR-Timer, retxBSR-Timer, and logicalChannelSR-DelayTimer. The MAC entity needs to handle these timers and triggers when it dynamically changes resource allocation mode. Similarly, for SR, the MAC entity may trigger an SR, and it maintains timers: sr-ProhibitTime. The MAC entity needs to handle these timers and triggers when it dynamically changes resource allocation mode.

When dynamically or semi-statically transitioning from Mode 2 to Mode 1, the MAC entity may have MAC PDUs in the HARQ buffers awaiting retransmissions. The SR/BSR mechanism may need to be modified to take into account these MAC PDUs. In addition, the UE may have configured sidelink grants. The MAC entity has to deal with these configured grants

Problem 3: MAC Procedures when UE has Simultaneous Mode 1/Mode 2

A third problem arises when a UE may have multiple simultaneous side links, with some using Resource Allocation Mode 1 and others using Resource Allocation Mode 2. If these sidelinks use the same MAC entity, then the Release 16 MAC procedures will not be able to distinguish which sidelink is associated with which resource allocation mode. The may result in an inefficiency in resource utilization as well as unneeded processing in the UE. For example, the UE may report a BSR for traffic that is to use Resource Allocation Mode 2. In addition, Sidelink Grant Determination does not take into account the logical channel. The grant is assigned for the UE, and the logical channel to use that grant is selected only after the grant is obtained (in Step 8 of FIG. 4). If a UE has simultaneous mode 1 and mode 2 with logical channels mapped to each of these, then the grants may need to be segregated at the MAC layer so that they are used for the proper/intended logical channel.

Example Solutions for Simultaneous Mode 1/Mode 2 Resource Allocation

Mode 1/Mode 2 MAC Architecture Options

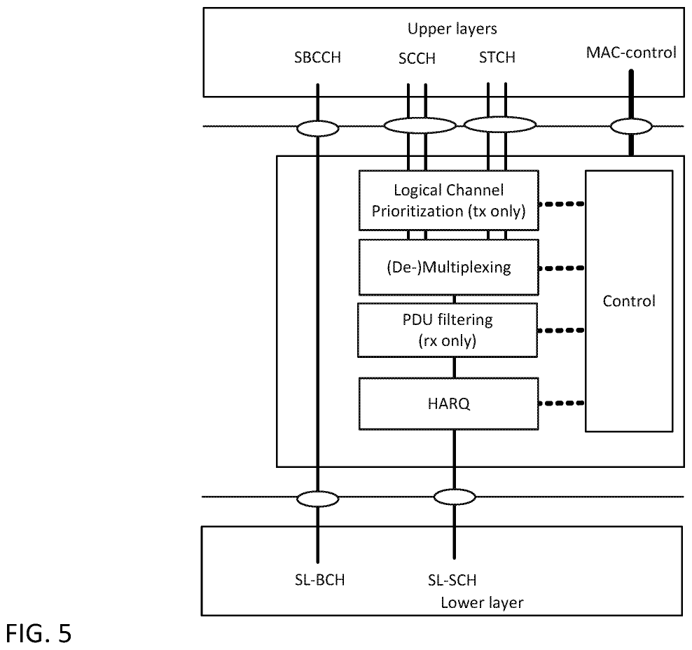

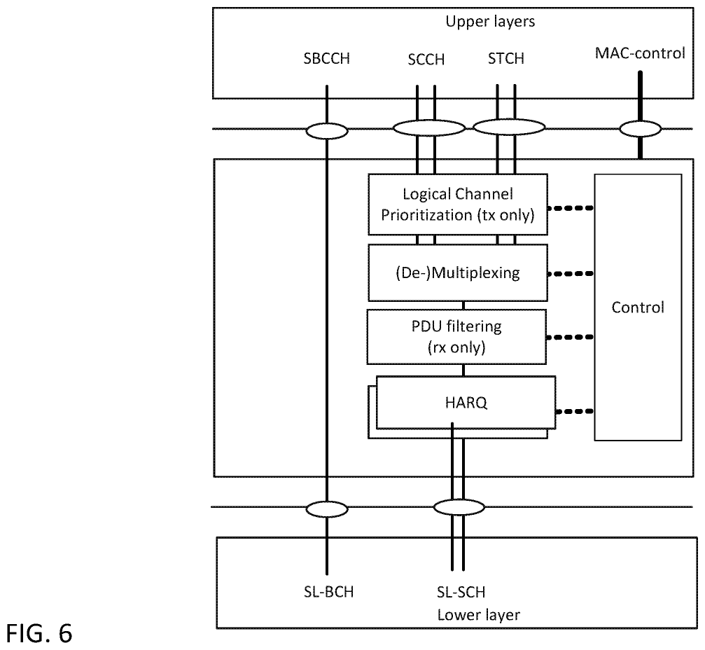

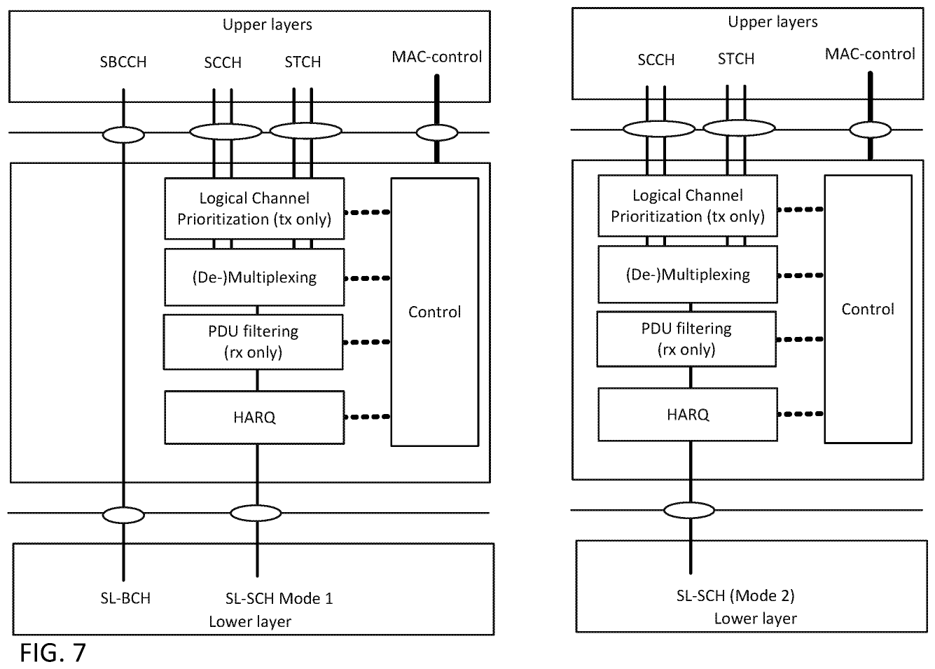

FIG. 5, FIG. 6, and FIG. 7 show the potential MAC architectures to support a UE that may allow simultaneous Mode 1 and Mode 2 Resource allocation.

In FIG. 5, the MAC entity for the SL-SCH and SL-BCH is bi-modal. As a result a single MAC entity handles grants, transmissions, and retransmissions for both resource allocation modes. The transmissions using Mode 1 and Mode 2 share the same single HARQ entity, which has a number of parallel HARQ processes.

In FIG. 6, the MAC entity for the SL-SCH and SL-BCH is also bi-modal. A single MAC entity handles grants, transmissions, and retransmissions for both resource allocation modes. However, the MAC entity has a separate HARQ entity for each resource allocation mode. This is to handle the different HARQ processing for both resource allocation modes.

In FIG. 7, a separate MAC entity is used for each resource allocation mode. Each MAC entity has its own HARQ entity and independent processing. This architecture may be preferred in cases where the resource allocation modes are operated on different carriers.

Mode 1/Mode 2 Use Over Tx Resource Pools

Tx Resource Pools may be configured to support one or both resource allocation modes. If a resource pool supports both allocation modes, we refer to this as a shared resource pool. If a resource pool supports only a single resource mode, we refer to this as a dedicated resource pool. In such cases, a network will likely have at least two dedicated Tx resource pools—at least one for Mode 1 operation, and at least one for Mode 2 operation. One other feature to consider about dedicated resource pools is if they are on the same carrier or on dedicated carriers.

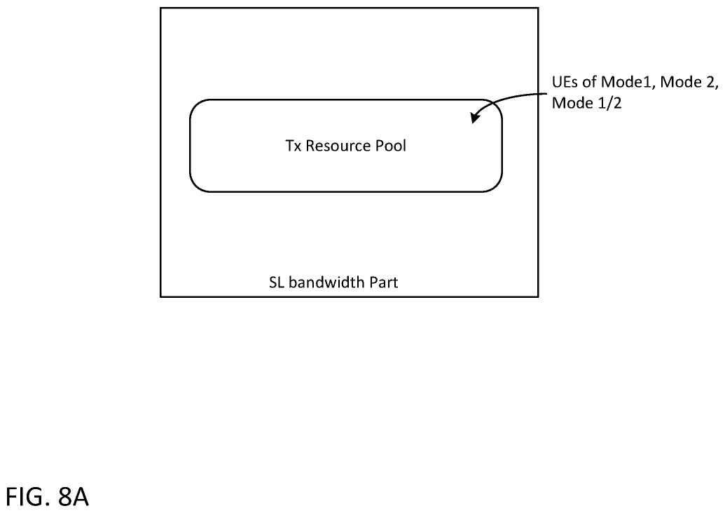

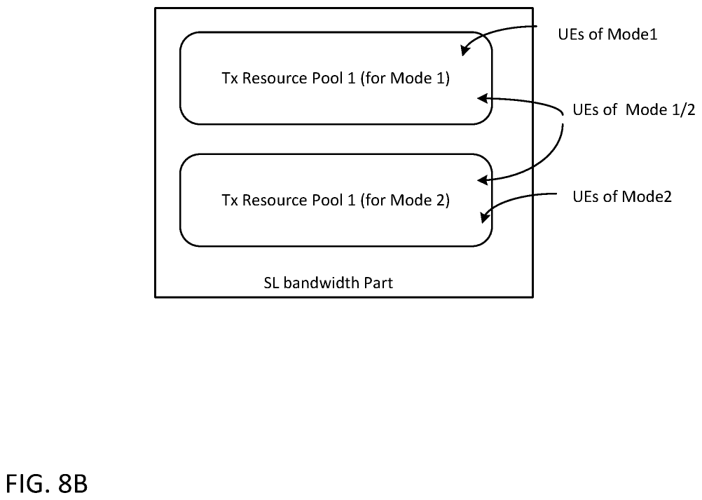

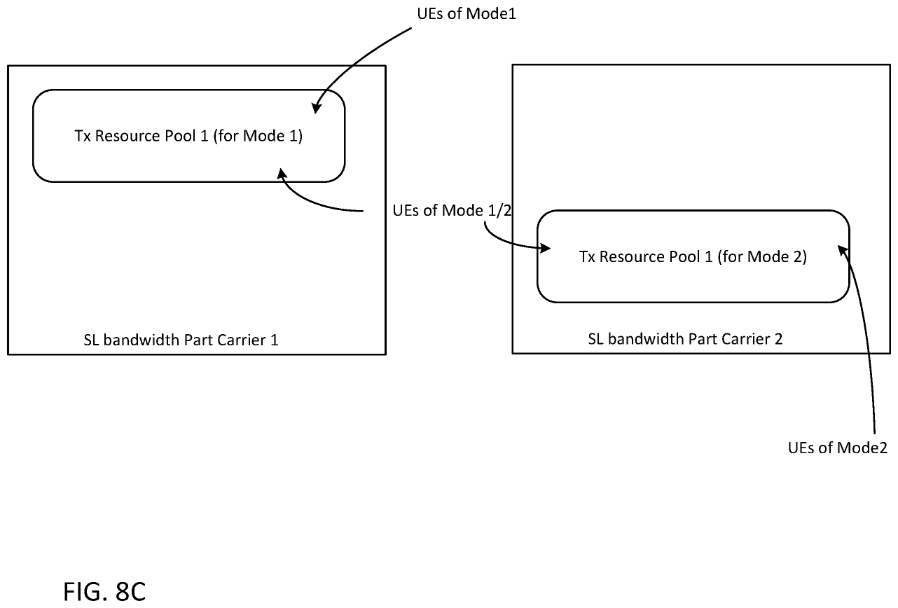

FIGS. 8A-8C illustrate example Tx resource pools. FIG. 8A shows an example of a carrier with a single shared Tx Resource pool. UEs using Mode 1 transmit on sidelink in this resource pool. UEs using Mode 2 transmit on sidelink in this resource pool, UEs that simultaneously use Mode 1 and Mode 2 (hereinafter referred to as Mode 1/2) transmit on sidelink in this resource pool.

FIG. 8B shows an example of a carrier with a single Tx Resource pool for Mode 1 operation (RP1) and a single Tx resource pool for Mode 2 operation (RP2). UEs using Mode 1 transmit on sidelink in RP1. UEs using Mode 2 transmit on sidelink in resource pool RP2, UEs using Mode 1/2 transmit on sidelink in either resource pool, depending on the resource allocation mode for the particular transport block.

FIG. 8C shows an example of a carrier with a single Tx Resource pool for Mode 1 operation (RP1) and a single Tx resource pool for Mode 2 operation (RP2), where RP1 and RP2 are on different carriers. UEs using Mode 1 transmit on sidelink in RPL. UEs using Mode 2 transmit on sidelink in resource pool RP2, UEs using Mode 1/2 transmit on sidelink in either resource pool, depending on the resource allocation mode for the particular transport block.

Mode 1/Mode 2 Use by a UE

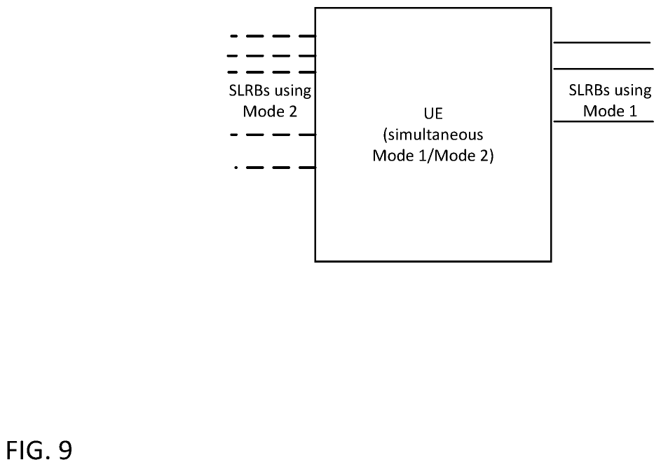

UE may have one or more sidelink radio bearers (SLRBs). In Release 15 NR V2X, release allocation mode was associated with a UE, and all SLRBs of the UE used that same resource allocation mode. A UE could change resource allocation mode, for example at a handover, upon RRC state, etc. However, the change in resource allocation mode would apply to all SLRBs of the UE. Since SLRBs may have significantly different QoS requirements, it may be beneficial to independently associate these to different resource allocation modes. Some SLRBs using Mode 1, some SLRBs using Mode 2, and some SLRBs allowed to dynamically or semi-statically change from Mode 1 to Mode 2 depending on one or more factors (see section: Triggers to Change Mode). This is shown in FIG. 9.

A UE may be (pre)configured with a mapping to resource allocation mode. The mapping may be related to cast type, destination layer 2 ID, priority of sidelink traffic, delay requirement of sidelink traffic, control plane data vs user plane data, etc. For example, when the UE starts a sidelink connection to a specific destination layer 2 ID, the mapping may indicate that sidelink traffic to this destination should be configured with a SLRB using Mode 2. As another example, when the UE starts a sidelink connection that has a high priority, the mapping may indicate that sidelink traffic for this high priority should be configured with a SLRB using Mode 1. As another example, when the UE starts a sidelink connection the mapping may indicate that the sidelink signaling radio bearers should be configured with a SLRB using Mode 1 and the sidelink data radio bearers should be configured with a SLRB using Mode 2.

Triggers to Change Mode

Numerous events or triggers may result in a UE changing the resource allocation mode of one or more of its SLRBs. Eight example triggers are as follows.

First, the UE SLRB may be (pre)configured with a resource allocation mode schedule. It would then use a form of Time Division Multiplexing (TDM) between Mode 1 and Mode 2. For example, a gNB may want to reduce the signaling load during peak hours, so the gNB may configure the UE to use Mode 2 during these hours, and Mode 1 during the off-peak hours. The schedule may be included with other SLRB configuration. The schedule may be activated and deactivated through sidelink RRC configuration.

Second, the UE may send a time grant request for use of mode 2 resource, for example, based on UE knowledge of traffic pattern or application running on the UE. The request may include an indication that the UE requires/prefers Mode 2 resource allocation for a specific window—e.g. K slots starting after slot M. The UE may also negotiate the grant pattern with the gNB. The grant request may be sent via a new RRC message or a new IE in the SidelinkUEInformationNR RRC message, a new IE in the UEAssistanceInformation RRC message. Alternatively, the request may be sent through a MAC CE or through PHY layer signaling (for example, the UCI).

Third, the UE SLRB may be configured with thresholds related to load. For example related to channel busy ratio (CBR), or channel occupancy (CO). If the measured load is above this configured threshold, the UE may change to resource allocation mode to Mode 1 for this SLRB, in order to reduce the probability of collision on the sidelink resources. Similarly if the load is below this threshold, the UE may change to resource allocation mode to Mode 2 for this SLRB, in order to reduce the transmission latency. Note that the thresholds may be (pre)configured per UE or per SLRB. In addition, the configuration may have 2 thresholds (one for triggering a Mode 2-to-Mode 1 transition, and another for triggering a Mode 1-to-Mode 2 transition)

Fourth, the UE SLRB may be configured with thresholds related to remaining packet delay budget. For example, if the UE determines that the packet delay budget will no longer be met for a MAC PDU, it may change the resource allocation mode to Mode 2.

Five, the UE SLRB may be configured to toggle the resource allocation mode based on whether the UE is monitoring PDCCH on its Uu link. For example, if the UE is configured with a DRX cycle for its Uu link, the UE may change the resource allocation mode to Mode 2 during the DRX OFF periods (periods when the UE is not listening for PDCCH). The UE may change the allocation mode for one or more SLRBs. As another example, if the UE is configured with a Measurement Gap, the UE may change the resource allocation mode to Mode 2 during the planned gaps (periods when the UE is not listening for PDCCH). The UE may change the allocation mode for one or more SLRBs.

Sixth UE SLRB may be configured to toggle the resource allocation mode based on RRC state of the Uu link. For example, if the UEs Uu link us in RRC_INACTIVE, rather than resuming the RRC connection, the UE may change the resource allocation mode to Mode 2.

Seventh UE SLRB may be configured to toggle the resource allocation mode based on request from a gNB or a Controlling UE. This may be via RRC signaling, for example a sidelink RRC reconfiguration, or through a MAC CE or through a PHY layer mechanism, such as the DCI or SCI.

Eighth, The UE SLRB may be configured to toggle the resource allocation mode based on request from higher layers (PC5-S).

RRC Processing for Simultaneous Mode 1/Mode 2

In Release 16 NR V2X, the resource allocation mode decision was under the control of the gNB and could be changed through sidelink RRC reconfiguration. For RRC_CONNECTED mode, the gNB would configure only one Mode. If a UE is to support simultaneous Mode 1 and Mode 2 operation, the gNB must configure both Modes.

In order to enable the gNB to configure both modes, the gNB must be aware if the UE is capable of supporting simultaneous Mode 1/Mode 2. It is proposed that this capability be added as a new UE capability and provided to the serving cell in a UECapabilityEnquiry exchange, a new RRC message exchange, or a NAS layer message exchange. For example, this may be in a new sl-Parameters IE that is included in the UECapabilityInformation message. When configuring the SLRBs for the UE, the network would then include a configuration for both Mode 1 (for example through the SL-ScheduledConfig IE) and Mode 2 (for example through the SL-UE-SelectedConfig IE). In addition, the network would also include the resource allocation mode to be used for each SLRB. For example, a new resourceAllocation IE included in the SL-RadioBearerConfig IE, or SL-RLC-BearerConfig IE, or SL-RLC-Config IE.

Power Control for PSSCH Simultaneous Mode 1/Mode 2

Some UEs may be capable of simultaneously transmitting multiple sidelink MAC PDUs. For example the UE may have dedicated resource pools (over the same carrier). One pool may be for Mode 1 resource allocation while another pool may be for Mode 2 resource allocation. In such cases, sidelink transmissions may occur in the same slot. In addition, it may also be possible for the UE to have uplink transmissions. As a result, if the UE is capable, it may transmit the uplink MAC PDU simultaneously with the one or more sidelink MAC PDUs.

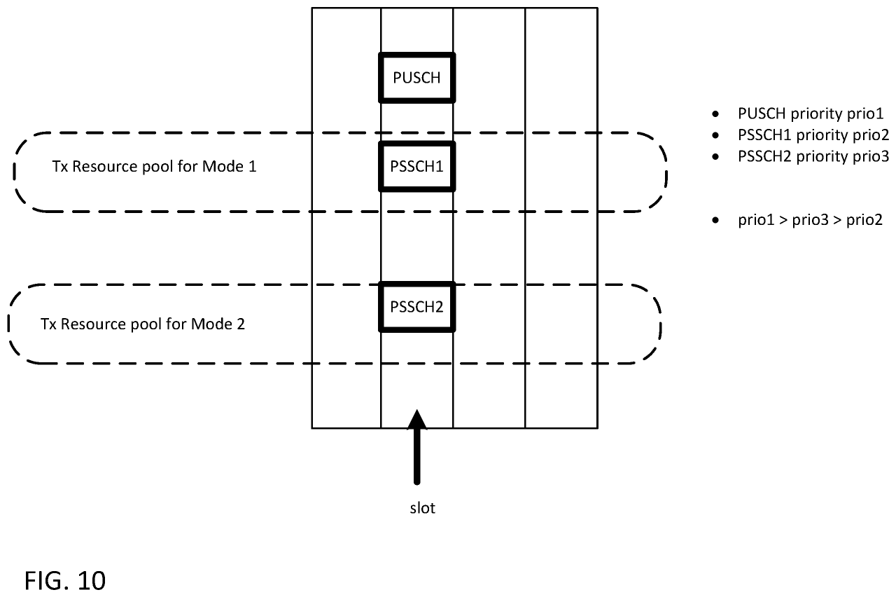

In the general case, a UE may simultaneously transmit a number of MAC PDUs. One on PUSCH and one or more on PSSCHs. In such cases, the UE must guarantee that its transmitted power does not exceed the maximum UE power (defined as P_CMAX). If the power control of each of the shared channels is managed independently, it is possible that the maximum is exceeded. To prevent this, we propose that the power control calculations for each of the channels take into account the power that is already allocated to the other channels of higher priority. The overall process is explained with the aid of FIG. 10. Here we see that we have three channels (PUSCH, PSSCH1, and PSSCH2) that have to be power controlled. The UE determines the priority of each of the MAC PDUs on these channels (respectively prio1, prio2, prio3). For explanatory purposes, assume that prio1 is higher than prio3 which is higher than prio2. The power control algorithm is run for the channel with the highest priority (PUSCH). The resulting power is then used as an input to the power control algorithm for channel with the next highest priority (PSSCH2). The power control algorithm for PSSCH2 will take into account the power already allocated for PUSCH. The resulting powers used by PUSCH and PSSCH2 are then used as input to the power control algorithm for the channel with the lowest priority (PSSCH1). The power control algorithm for PSSCH1 will take into account the power already allocated for PUSCH and PSSCH2.

Shared Resource Pools—MAC Processing for Simultaneous Mode 1/Mode 2

In a shared resource pool, the UE is likely to use MAC Architecture 1 or MAC Architecture 2. Both these architectures share a single MAC entity, with the main difference that MAC Architecture 2 has a separate HARQ entity for each allocation mode. In Release 15 NR V2X, the MAC entity assumes that the UE operates either in Mode 1 or in Mode 2. If a UE is allowed to use Mode 1 and Mode 2 simultaneously, changes are required in the MAC protocol. These changes are described below.

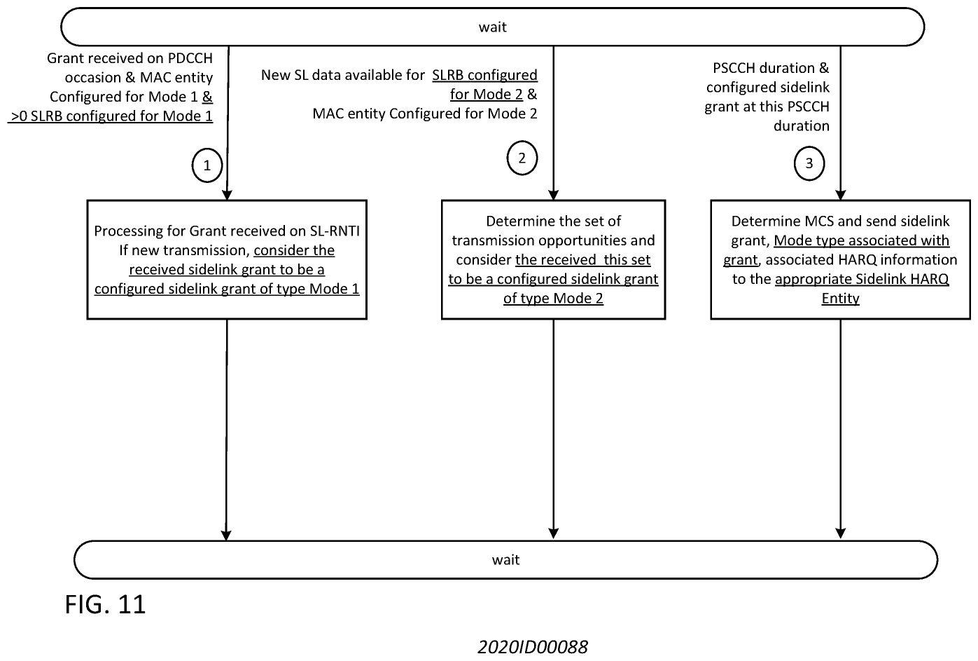

During Sidelink Grant Reception, the MAC layer may mark the sidelink configured grants as either of Type Mode 1 or Mode 2. The proposed modified procedure is depicted in FIG. 11—the modifications to the Release 16 NR V2X Sidelink Grant Determination are shown underlined. A MAC entity may be simultaneously configured for both Mode 1 and Mode 2. If a sidelink grant is received on a PDCCH (path 1 in figure), this grant is only processed if UE has at least one SLRB configured for Mode 1. If so, the grant is processed, and marked/considered as a configured sidelink grant of type Mode 1. Similarly, if the UE has new sidelink data available for a SLRB configured for Mode 2 transmission (path 2 in figure), the MAC layer determines the set of transmission opportunities and marks/considers this set as a configured sidelink grant of type Mode 2. At the PSCCH duration where configured sidelink grant is to be used (path 3 in figure), the MAC layer determines the MCS, and sends the sidelink grant, MCS, along with the grant type to the appropriate HARQ entity. The last step needed if the MAC entity has a separate HARQ entity for each allocation mode.

During Tx resource (re-)selection check, the MAC layer checks if the resources used for the configured sidelink grants need to be re-selected. Many events may trigger this (re)selection. If a UE is allowed to use Mode 1 and Mode 2 simultaneously, and this UE has configured sidelink grants of both types, it should execute the Tx resource (re-)selection check only on those configured sidelink grants of Type Mode 2.

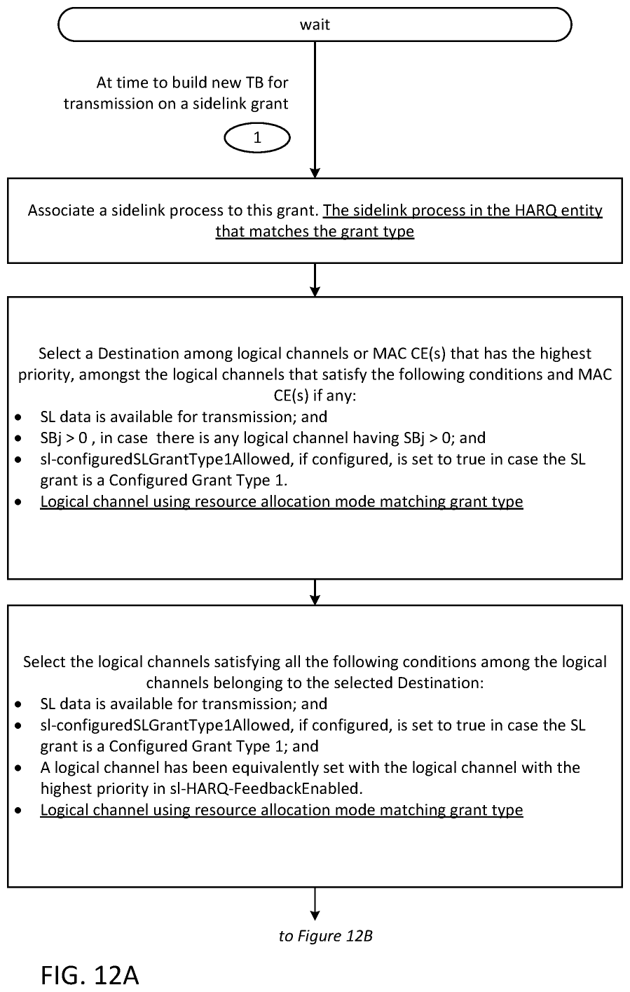

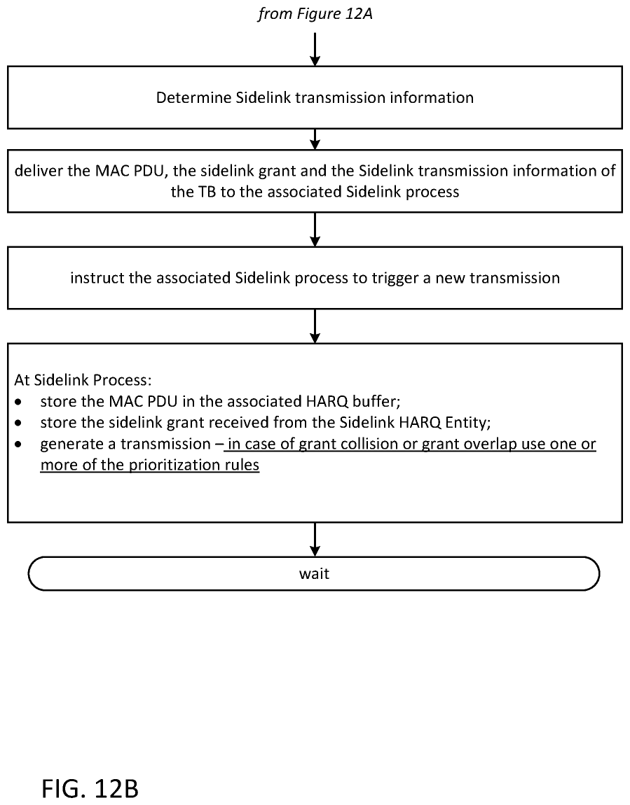

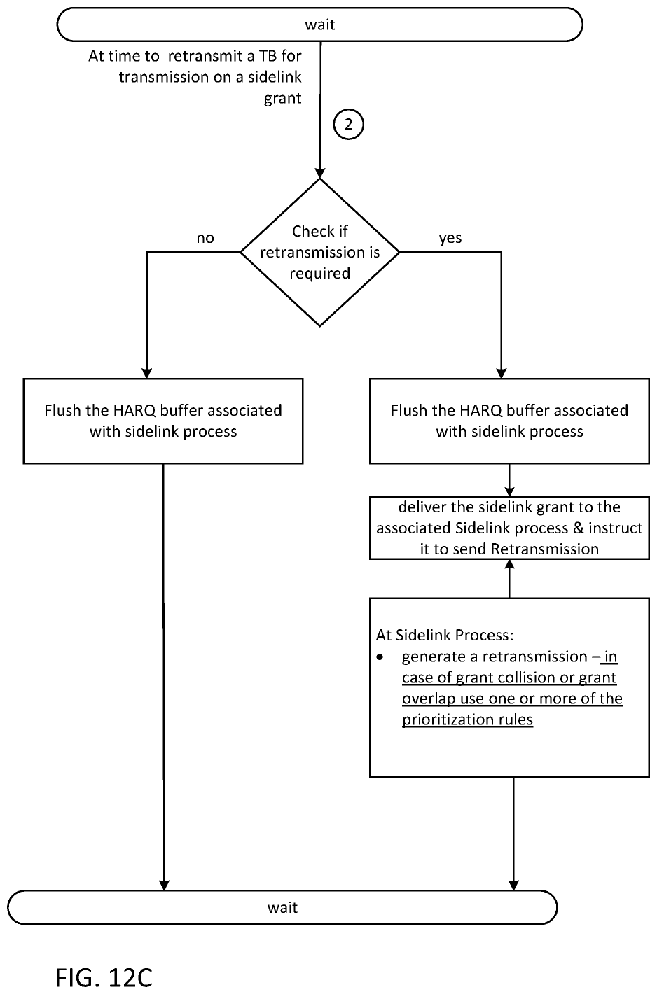

During HARQ Entity process, at the appropriate time, the MAC layer builds a new MAC PDU for transmission on a configured sidelink grant (path 1 in FIG. 12A) or instructs the physical layer to retransmit a MAC PDU (path 2 in FIGS. 12B and 12C). In FIGS. 12A-12C, modifications to the Release 16 NR V2X HARQ Entity processing is shown underlined. Note that in path 1, the HARQ entity should take into account new logical channel restrictions to limit the destination selection and logical channel selection. So, if the configured sidelink grant is of type Mode 1, the destination selection considers only those logical channels from SLRBs that are configured for Mode 1. Similarly, if the configured sidelink grant is of type Mode 2, the destination selection considers only those logical channels from SLRBs that are configured for Mode 2. In addition when building the MAC PDU for the selected destination and grant type, the HARQ entity will only select logical channels that match at least the destination and grant type. Subsequently, the sidelink process handling the MAC PDU will generate a transmission. In case of a grant collision or grant overlap, as discussed in a subsequent section, the HARQ entity must select one of the grants. Rules for this selection are described in the Grant Overlap and Grant Collision section. Note that grant collision or grant overlap may also occur in path 2 of FIGS. 12B and 12C, and the same rules may apply. Note also that the above description and the flowchart in FIGS. 12A-12C show that the resolution of grant collision or grant overlap is done as the last step of the HARQ Entity process. It should be understood that this is only one typical alternative. The resolution can occur at an earlier phase of the HARQ Entity process, for example as a first step in the HARQ entity process, upon entering the HARQ Entity process.

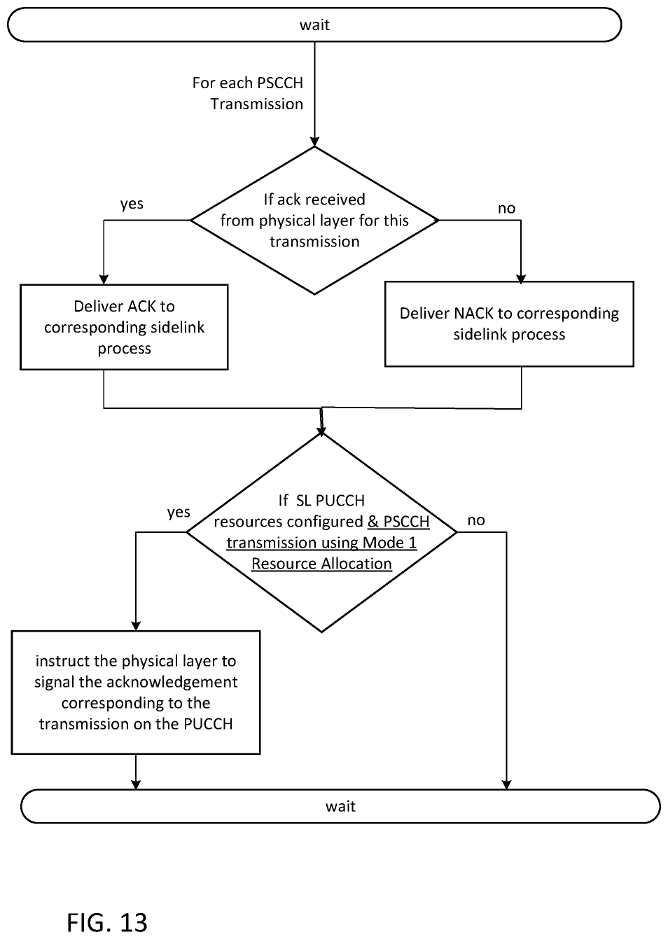

During Sidelink Feedback process, the MAC Entity delivers an acknowledgement or negative acknowledgement indication to the appropriate sidelink process. Also if the sidelink PUCCH resources are configured, the MAC entity asks the physical layer to signal the acknowledgement to the gNB. However, if the MAC entity supports simultaneous Mode 1 and Mode 2 transmissions, the Sidelink Feedback process should check whether the acknowledgement was received for a MAC PDU transmitted using Mode 1 resource allocation. If so, then the MAC entity may ask the physical layer to signal the acknowledgement to the gNB. The modified Sidelink Feedback process is shown in FIG. 13 (modifications to the Release 16 NR V2X Sidelink Feedback process is shown underlined).

During Sidelink Buffer Status Report (SL-BSR) handling, the MAC entity manages and sends BSRs to the gNB. In Release 16 NR V2X, if the MAC entity is configured for BSR reporting, the BSR handling is done for all logical channels (as these are all using resource allocation Mode 1). In a case where the UE may be configured with simultaneous Mode 1 and Mode 2, this buffer status reporting should not be across all logical channels, but rather, only for logical channels that are configured for Mode 1 resource allocation. To implement this, the SL-BSR handling should only allocate to a logical channel group (LCG), those logical channels configured to use resource allocation Mode 1. Furthermore, triggers for SL-BSR should include only those logical channels to a Destination that are relying on resource allocation Mode 1.

Grant Collision & Grant Overlap

If a UE is capable of supporting simultaneous Mode 1 and Mode 2 operation, it will be receiving grants from the gNB for some logical channels, and it will be generating grants autonomously for other logical channels. In a case where the Mode 1 and Mode 2 transmissions occupy a shared resource pool, the grants can collide, or overlap in time (for example scheduled for the same slot). In both cases, the UE will have access to two grants but may only be allowed to use one of these. At the PSCCH duration over which the grants collide or overlap, the MAC layer has to choose between the two grants. This choice may be made according to one or more of the following eight criteria, for example.

First, the grant is chosen based on rules between Mode 1 and Mode 2 operation. In one alternative, Mode 2 grants may always be prioritized over Mode 1 grants. In another alternative, Mode 1 grants may always be prioritized over Mode 2 grants. In another alternative, the rule between Mode 1 or Mode 2 may be (pre)configured by the serving cell. For example, this may be part of the sidelink common configuration or as part of the sidelink dedicated configuration.

Second, the grant is chosen based on the priority of the logical channel data that will be transmitted on the grant. See additional details in the Priority Based Selection.

Thirds, the grant is chosen based on the number of resources in the grant, in order to maximize the size of the transmitted transport block.

Fourth, the grant is chosen based on whether it is used fora new transmission or a retransmission. The MAC layer may always prioritize retransmissions. Alternatively, the MAC layer may always prioritize new transmissions.

Fifth, the grant is chosen based on the cast type. The MAC layer may always prioritize unicast traffic over groupcast over broadcast. Alternatively, the MAC layer may always prioritize groupcast traffic over unicast over broadcast. Alternatively, the MAC layer may always prioritize broadcast traffic over unicast over groupcast.

Sixth, the grant is chosen based on a “grant priority” configured by the serving cell. This may be a different priority than the logical channel priority. Using this mechanism, the serving cell has full flexibility in deciding whether a UE should prioritize Mode 1 or Mode 2 transmissions, in case of a collision or overlap. Upon configuring the UE, the gNB may assign a “grant priority” to Mode 2. Subsequently, when issuing a Mode 1 grant, the gNB may include a “grant priority” in the grant. In case of collision or overlap, the UE may then compare the “grant priority” in the Mode 1 grant, to the configured Mode 2 “grant priority”. Based on this comparison, the UE may select between the Mode 1 or Mode 2 grant.

Seventh, the grant is chosen based on the destination of the transport block. Certain destinations may be prioritized over other destinations. For example, this may be the case if a peer UE is acting as a Scheduler UE or a Controller UE. Grants that will include data to these destinations may be prioritized. The list of prioritized destinations may be part of the sidelink common configuration or as part of the sidelink dedicated configuration.

Eighth, the grant is chosen based on the load in the cell. For example, if the CBR measurements indicate a heavily loaded cell, the MAC layer may be better off selecting the Mode 1 resource grant, as there is a higher chance of collision if the Mode 2 grant is used. Conversely, if the CBR measurements indicate a lightly loaded cell, the MAC layer may be better off selecting the Mode 2 resource grant, as it would result in very low latency.

Note that these conditions for grant selection may be combined. For example, the MAC layer may use destination for a first pass to determine the grant selection. If not conclusive, that is the grants are headed to the same peer destination UE, the MAC layer may rely on the load in the cell.

Also note that in cases where the MAC layer selects one grant over another, the MAC layer may take some action so that the UE and/or the serving cell is aware that the grant was not used. For example if the MAC layer selects the Mode 2 grant, the UE may send an indication to the serving cell so that the serving cell may generate a new grant. This indication may be sent through an RRC message, a MAC control element, or through Uplink Control Information. Conversely, if the MAC layer selects the Mode 1 grant, the MAC layer may decide to modify the configured grants for that transport block. For example a Sidelink Grant Reception process may have determined configured grants for a new transmission and K retransmissions. If the first (new) transmission is not sent because of a collision or overlap with a Mode 1 grant, the MAC layer may send the initial transmission in the first configured grant that was originally destined for a first retransmission.

Priority Based Selection

The grant to use may be based on priority. A sidelink transmission from one UE to a peer UE, may include one or more of the following: PC5-S message control plane data; RRC message control plane data; Sidelink user plane data; MAC control element for CSI report; MAC control element for Sidelink BSR, with exception of Sidelink BSR included for padding; and MAC control element for BSR included for padding.

The MAC layer may determine which grant to use based on absolute priorities. For example, for a case where both grants are to carry only sidelink user plane data, the MAC layer may determine the highest priority logical channel that will use the respective grant. It may then compare the absolute priorities and select the grant that is associated with the highest priority. Alternatively, the MAC layer may use priority thresholds to determine which grant to choose. The UE may be configured with grant thresholds: ModelGrantThreshold and/or a Mode2GrantThreshold. For example, this may be part of the sidelink common configuration or as part of the sidelink dedicated configuration. MAC layer may determine the highest priority logical channel that will use the respective grant. If this priority is higher than the grant threshold, then the grant associated with the logical channel is prioritized. The absolute priorities may also be used in cases that one or both grants carry control plane data. In this case, the MAC layer may use the logical channel priority of the control plane data (PC5-S or RRC). The absolute priorities may also be used in cases that one or both grants carry MAC control elements. In this case, the MAC layer may use the logical channel priority of the data associated with the MAC control element. For example, if the UE is sending a BSR, the MAC layer may consider the priority, as the logical channel priority of the logical channel with the highest priority of those logical channels whose buffer status is included in the BSR report. Alternatively, the MAC layer may use relative priorities to determine which grant to select. The relative priorities of the sidelink transmission types may be fixed/standardized. For example, the list above may be one example of a fixed relative priority list. Using this relative priority, RRC control plane data is prioritized over sidelink user plane data or a BSR report.

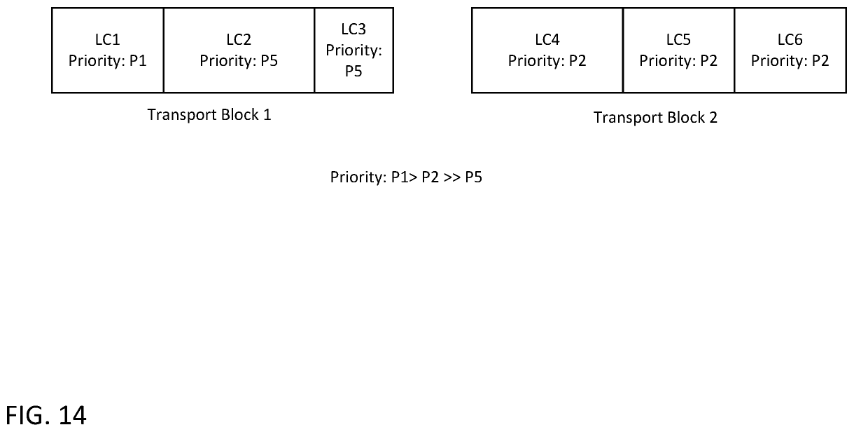

Note that the priority information associated with a grant may be based on the priority of the logical channel with the highest priority that is to be carried in the grant resources. However, this fails to take into account priority of the other logical channels that are multiplexed in the transport block to be carried on the grant. This may result in situations as depicted in FIG. 14. Here we see two transport blocks. One has traffic multiplexed from three logical channels (LC1, LC2, LC3 (of which only 1 has a high priority (P1)). The other has traffic multiplexed from three other logical channels (LC4, LC5, LC6), and all three have a relatively high priority, although all lower than the P1. In such a case, looking at only the highest priority would favor selecting the grant associated with logical channels: LC1, LC2, LC3. However, in this case, the MAC layer may be better off selecting the grant associated with logical channels: LC4, LC5, LC6 as the transport block carries more SDU's of high priority. It is proposed that the MAC layer may determine an aggregate priority for each grant and compare the aggregate priority when making a determination of the grant to select. Determination of the aggregate priority may be based on a weighted average of the priorities of each logical channel carried in the transport block.

Note also that the selection rules may be different depending on whether the grants collide or overlap in time.

Measurements for Simultaneous Mode 1/Mode 2

In cases where a cell has UEs using resource allocation Mode 1, Mode 2, and/or Mode 1/2, some scheduled grants (dynamic grants or configured grants of Type 1 or Type 2) to the Mode 1 UEs may overlap with grants autonomously derived by the Mode 2 UEs. This occurs as the resource allocation in the Mode 2 UEs may not be able to take all the scheduled grants (for Mode 1 UEs) into account when determining its candidate resource set. In order to avoid these grant overlaps, the gNB may avoid scheduling grants on resources that may be used by Mode 2 UEs. The gNB may obtain such information from the physical layer resource allocation sensing results, for example the candidate resource set. It is proposed that this candidate resource set measurement result be provided to the serving cell, through a MeasurementReport message. In order to provide this information to the gNB, the UE using Mode 1 resource allocation must be configured for this measurement. This configuration may include the following six items, for example. First is periodicity of the measurement report. Second is the resource pool to measure.

Third is the number of sub-channels to be used for the PSSCH/PSCCH transmission in a slot, LsubCH. Alternatively, the LsubCH may be set to a (pre)configured default value, for example 1 subchannel.

Fourth is a resource reservation interval, P_{rsvp_TX}. Fifth is a L1 priority, prio_{TX}. Sixth is the size of the observation window (typically referred to as T_o).

The measurement report may include the results of the sensing in a bitmap. It may also provide an indication of the selection window over which the sensing results are valid. This may include a starting or reference slot and a size or duration.

Note that the above assumes that the measurement report triggers are periodic. The measurement report may also be event driven. For example, when the sensing results have changed by more than a certain configured threshold.

Note that in cases the UE is configured for simultaneous Mode1/Mode2, the gNB need not provide all the measurement configuration information above, as the UE may already configured to generate the sensing results for the SLRBs using Mode 2. For example, in such cases, the measurement configuration may include only the periodicity of the measurement report. Alternatively, the gNB may provide all the measurement configuration information above, but the UE has the option to ignore it and use the configuration for its Mode 2 SLRBs.

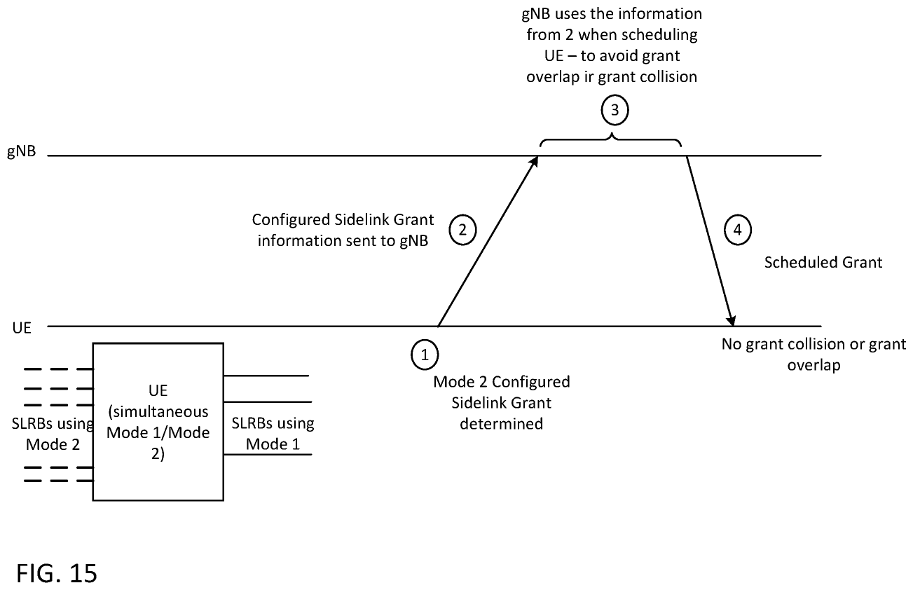

In addition, for UEs that have simultaneous Mode 1/Mode 2, the UE may provide the actual Mode 2 sidelink configured grant information to the gNB, so that the gNB can schedule the Mode 1 SLRBs of this UE to avoid grant collision and/or grant overlap. The overall process is depicted in FIG. 15. Here, the UE has some SLRBs using Mode 1 resource allocation and other SLRBs using Mode 2 resource allocation. When new sidelink data arrives for SLRBs using Mode 2, the UE generates the sidelink configured grant for the initial MAC PDU transmission and its HARQ retransmissions, as well as potentially other MAC PDUs and their HARQ retransmissions (step 1). The UE may send this configured sidelink grant information to the gNB. This may be through a dedicated RRC message, a new IE in the SidelinkUEInformationNR RRC message, a new IE in the UEAssistanceInformation RRC message, or a new IE in the MeasurementReport RRC message. Alternatively, this information may be sent through a MAC CE or PHY layer signalling (for example the UCI). The message may be sent periodically, or it may be event driven (sent every time the MAC layer generates a new configured sidelink grant for a Mode 2 SLRB) (step 2). This new IE may include the configured grant information for the Mode 2 SLRBs. The gNB takes this information into account when scheduling the UE to avoid grant collision and/or grant overlap (step 3). The scheduled grant (sent over DCI) is sent to the UE (step 4).

Change in Resource Allocation Mode

A number of triggers can result in a logical channel changing from one resource allocation mode to another. When such a change in mode occurs at the UE, there are a number of steps that may need to be taken at the UE. These are described below depending on the direction of the change in Mode.

Mode 1 to Mode 2

In Mode 1 the UE has a number of ongoing activities: handling of dynamic grants, handling of configured grants, SL-BSR reporting, SL-SR transmissions, SL-HARQ-ACK feedback reporting, sidelink related measurements, HARQ processing. Each of these may be impacted after a transition from Mode 1 to Mode 2 resource allocation.

If after the change of mode, there are no more logical channels using Mode 1, the UE may perform one or more of the following six actions.

First, the UE may stop monitoring RNTIs related to Mode 1 operation. In particular stop monitoring for dynamic and configured grants (SL-RNTI and SLCS-RNTI)

Second, the UE may clear any received dynamic grant that is scheduled for an upcoming slot. The MAC layer may clear the PSCCH duration(s) and PSSCH duration(s) corresponding to these dynamic grants.

Third, the UE may clear any configured grant. In addition, if these configured grants are activated, the MAC layer may clear the PSCCH duration(s) and PSSCH duration(s) corresponding to these configured grants.

Fourth, the MAC layer may consider all triggered SL-BSR as cancelled, and may stop and clear all timers related to SL-BSR reporting: retx-BSR-Timer and periodic-BSR-Timer.

Fifth, the MAC layer may cancel all pending SRs that are triggered. In addition, the UE may stop all timers related to pending SRs: sr-ProhibitTimer

Sixth, the MAC layer may instruct the physical layer to stop the processing of sidelink HARQ-ACKs, and to not send the HARQ-ACK information over the configured PUCCH.

If after the change of mode, the UE has at least one logical channel still using Mode 1, the UE may perform one or more of the following five actions.

First, the UE may clear any received dynamic grant that is scheduled for an upcoming slot and that is targeting the logical channel that has changed mode. The MAC layer may clear the PSCCH duration(s) and PSSCH duration(s) corresponding to these dynamic grants.

Second, the UE may clear any configured grant that is targeting the logical channel that has changed mode. In addition, if these configured grants are activated, the MAC layer may clear the PSCCH duration(s) and PSSCH duration(s) corresponding to these configured grants.

Third, if the UE has triggered SL-BSR, and any one of these triggered SL-BSR only includes buffer status for logical channels that are now using Mode 2, the MAC layer may consider these triggered SL-BSR as cancelled, and may stop and clear all timers related to SL-BSR reporting: retx-BSR-Timer and periodic-BSR-Timer.

Fourth, if the UE has triggered SL-BSR, and these triggered SL-BSR include buffer status for logical channels using Mode 1 and Mode 2, this BSR should not be cancelled.

Fifth, if the UE has a pending SR, and this SR was triggered by a logical channel that has changed mode the MAC layer may cancel this pending SRs. In addition, the UE may stop all timers related to pending SR: sr-ProhibitTimer.

Upon PSFCH reception for the transport block of the logical channel that has changed mode, the MAC layer should not instruct the physical layer to signal the acknowledgement corresponding to the transmission on the PUCCH.

After a change to Mode 2, there may be any number of transport blocks in the HARQ processes that have not yet been acknowledged. There is no Mode 2 configured grant available for these transport blocks. The MAC layer may either immediately flush these buffers and clear the HARQ processes. Alternatively, the HARQ process may ask the Sidelink Grant Reception process to create Mode 2 configured grants for these transport blocks. For example, the HARQ process may mark these transport blocks as “awaiting Mode2 Grant”. The Sidelink Grant Reception will then use this as a new trigger to determine configured grants for these transport blocks. In this determination, it may use a default value for packet delay budget of the transport block. This default value may be (pre) configured by the serving cell. For example, this may be part of the sidelink common configuration or as part of the sidelink dedicated configuration.

Lastly after a change in mode of a logical channel, the UE may send an indication to the serving cell that one or more of its logical channels is using Mode 2. This indication may be sent using an RRC message, a MAC control element, or through Uplink Control Information. As part of this indication, the UE may include the identity of the logical channel(s) that are changing mode. In response, the gNB may stop all grant processing for these logical channels.

Mode 2 to Mode 1

In Mode 2 the UE has a number of ongoing activities: determining configured grants for autonomous transmission, sensing to support the resource selection, HARQ processing. Each of these may be impacted after a transition from Mode 2 to Mode 1 resource allocation.

If after the change of mode, there are no more logical channels using Mode 2, the UE may clear Mode 2 configured grants. In addition, the MAC layer may clear the PSCCH duration(s) and PSSCH duration(s) corresponding to these configured grants. Further, the UE may stop sensing if the UE is not configured for Mode 1 UE sensing and reporting.

If after the change of mode, the UE has at least one logical channel still using Mode 2, the UE may clear Mode 2 configured grants targeting the logical channel that has changed mode. In addition, the MAC layer may clear the PSCCH duration(s) and PSSCH duration(s) corresponding to these configured grants.

After a change to Mode 1, the UE may not have all the configuration necessary for Mode 1 operation. For example, it may not have three items. First is UE specific PDCCH configuration for scheduling sidelink communication (carried in IE: sl-PDCCH-Config). Second is configuration for sidelink communication configurations used for network scheduled NR sidelink communication (carried in IE: SL-ScheduledConfig). Third is PUCCH configuration for sidelink communication (carried in IE: sl-PUCCH-Config).

In order to obtain this configuration, the UE may send an indication to the serving cell. This indication may be sent through an RRC message, through a MAC control element, or through Uplink Control Information. For the RRC message, the UE may use a modified RRCResumeRequest message or modified UEAssistanceInformation message, or through a new RRCReconfigurationRequest message. These messages indicate to the serving cell that the UE would like to be reconfigured for Mode 1 operation.

Dedicated Resource Pools for the Same Carrier

For dedicated resource pools for the same carrier, solutions similar to those for shared resource pools may be applied, such as: MAC processing for simultaneous Mode 1/Mode 2; grant overlap; measurements for simultaneous Mode 1/Mode 2; and change in resource allocation mode.

Example Environments

The 3rd Generation Partnership Project (3GPP) develops technical standards for cellular telecommunications network technologies, including radio access, the core transport network, and service capabilities—including work on codecs, security, and quality of service. Recent radio access technology (RAT) standards include WCDMA (commonly referred as 3G), LTE (commonly referred as 4G), and LTE-Advanced standards. 3GPP has begun working on the standardization of next generation cellular technology, called New Radio (NR), which is also referred to as “5G”. 3GPP NR standards development is expected to include the definition of next generation radio access technology (new RAT), which is expected to include the provision of new flexible radio access below 6 GHz, and the provision of new ultra-mobile broadband radio access above 6 GHz. The flexible radio access is expected to consist of a new, non-backwards compatible radio access in new spectrum below 6 GHz, and it is expected to include different operating modes that may be multiplexed together in the same spectrum to address a broad set of 3GPP NR use cases with diverging requirements. The ultra-mobile broadband is expected to include cmWave and mmWave spectrum that will provide the opportunity for ultra-mobile broadband access for, e.g., indoor applications and hotspots. In particular, the ultra-mobile broadband is expected to share a common design framework with the flexible radio access below 6 GHz, with cmWave and mmWave specific design optimizations.

3GPP has identified a variety of use cases that NR is expected to support, resulting in a wide variety of user experience requirements for data rate, latency, and mobility. The use cases include the following general categories: enhanced mobile broadband (e.g., broadband access in dense areas, indoor ultra-high broadband access, broadband access in a crowd, 50+ Mbps everywhere, ultra-low cost broadband access, mobile broadband in vehicles), critical communications, massive machine type communications, network operation (e.g., network slicing, routing, migration and interworking, energy savings), and enhanced vehicle-to-everything (eV2X) communications, which may include any of Vehicle-to-Vehicle Communication (V2V), Vehicle-to-Infrastructure Communication (V2I), Vehicle-to-Network Communication (V2N), Vehicle-to-Pedestrian Communication (V2P), and vehicle communications with other entities. Specific service and applications in these categories include, e.g., monitoring and sensor networks, device remote controlling, bi-directional remote controlling, personal cloud computing, video streaming, wireless cloud-based office, first responder connectivity, automotive ecall, disaster alerts, real-time gaming, multi-person video calls, autonomous driving, augmented reality, tactile internet, and virtual reality to name a few. All of these use cases and others are contemplated herein.

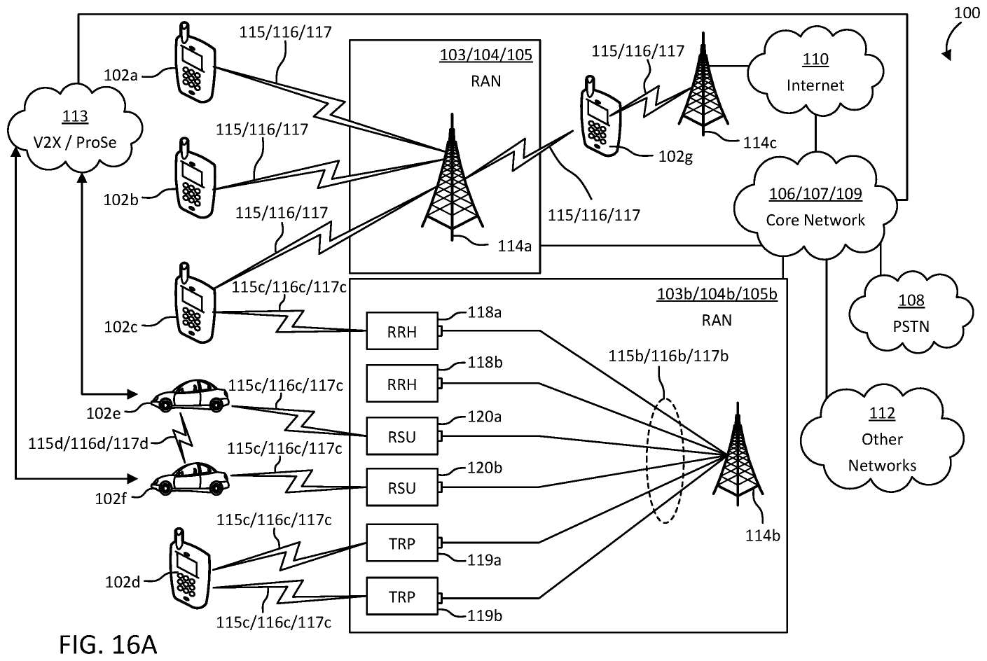

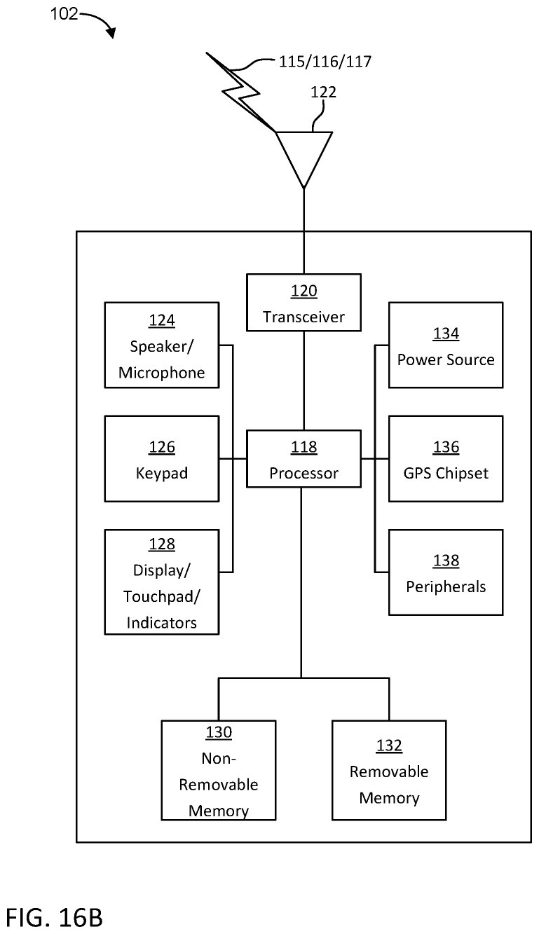

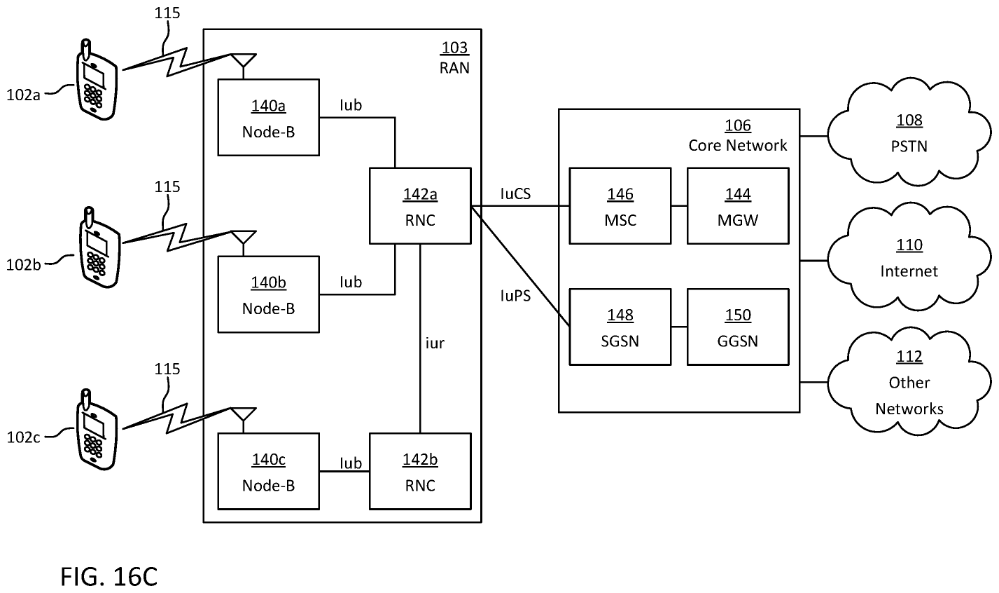

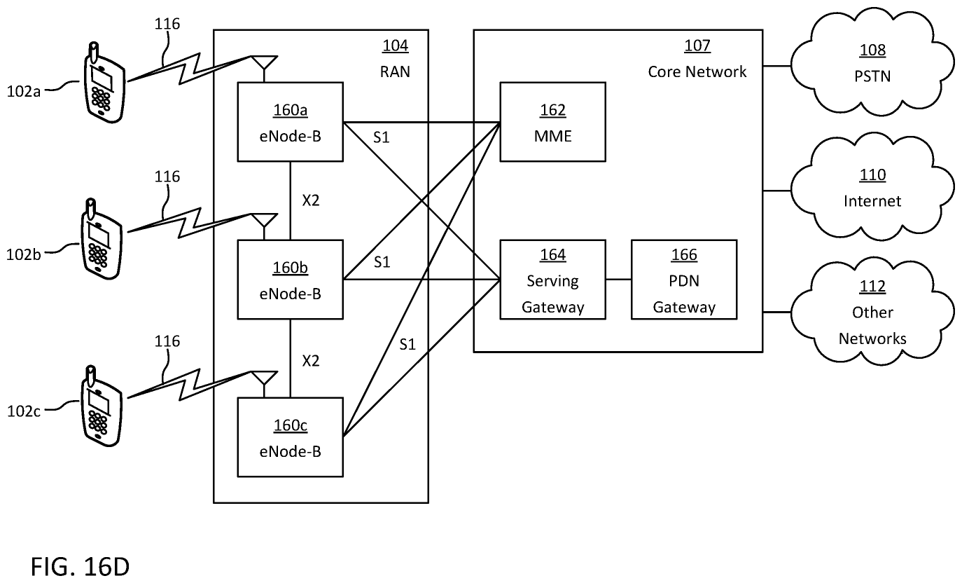

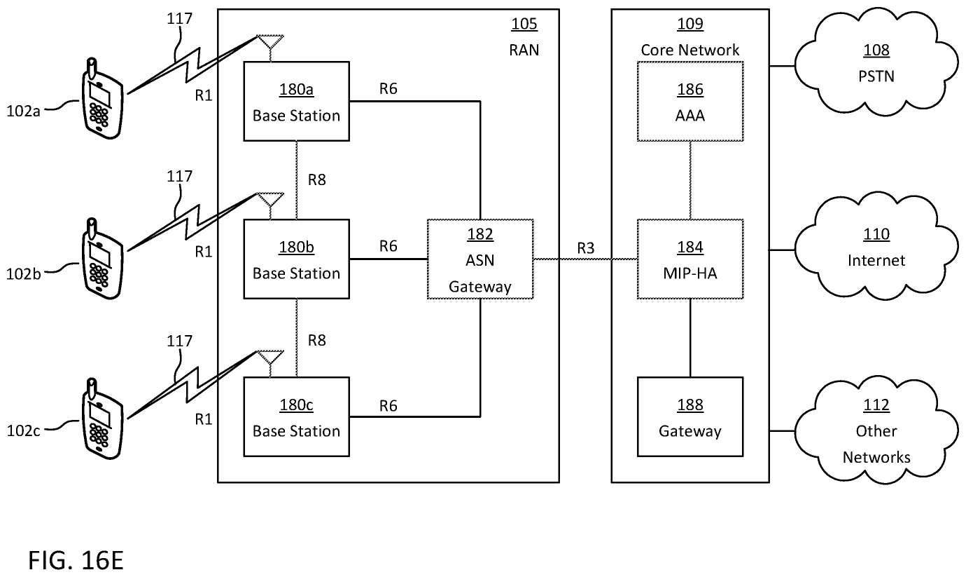

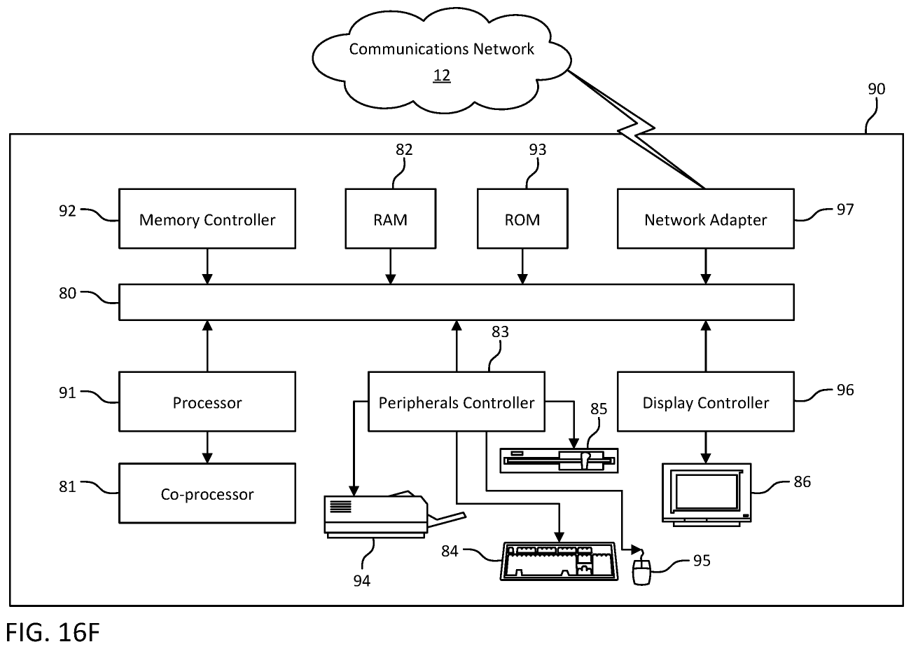

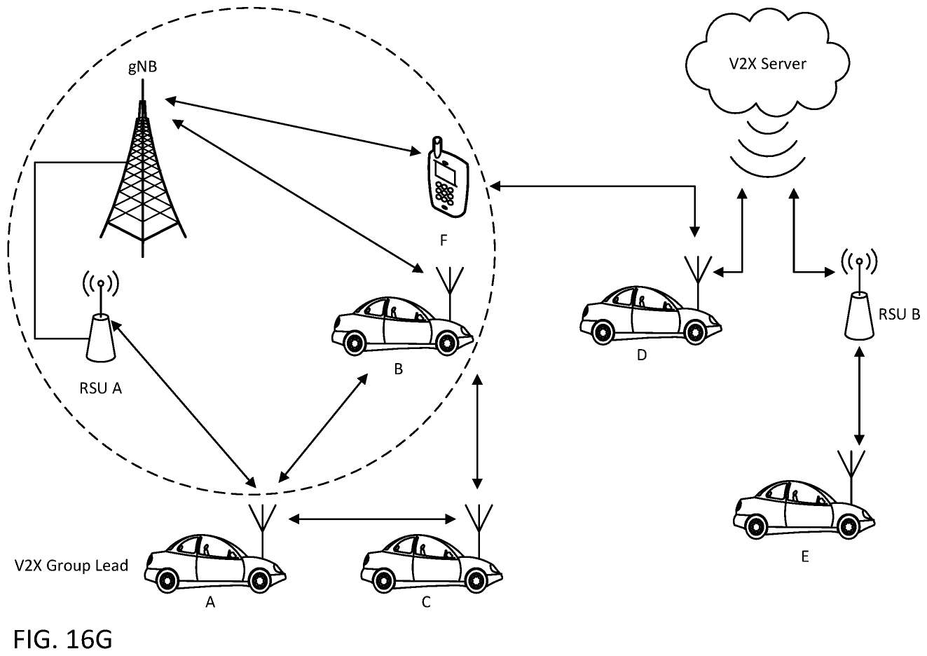

FIG. 16A illustrates one embodiment of an example communications system 100 in which the methods and apparatuses described and claimed herein may be embodied. As shown, the example communications system 100 may include wireless transmit/receive units (WTRUs) 102a, 102b, 102c, 102d, 102e, 102f, and/or 102g (which generally or collectively may be referred to as WTRU 102), a radio access network (RAN) 103/104/105/103b/104b/105b, a core network 106/107/109, a public switched telephone network (PSTN) 108, the Internet 110, other networks 112, and V2X server (or ProSe function and server) 113, though it will be appreciated that the disclosed embodiments contemplate any number of WTRUs, base stations, networks, and/or network elements. Each of the WTRUs 102a, 102b, 102c, 102d, 102e, 102f, and 102g may be any type of apparatus or device configured to operate and/or communicate in a wireless environment. Although each WTRU 102a, 102b, 102c, 102d, 102e, 102f, and 102g is depicted in FIGS. 16A-16E as a hand-held wireless communications apparatus, it is understood that with the wide variety of use cases contemplated for 5G wireless communications, each WTRU may comprise or be embodied in any type of apparatus or device configured to transmit and/or receive wireless signals, including, by way of example only, user equipment (UE), a mobile station, a fixed or mobile subscriber unit, a pager, a cellular telephone, a personal digital assistant (PDA), a smartphone, a laptop, a tablet, a netbook, a notebook computer, a personal computer, a wireless sensor, consumer electronics, a wearable device such as a smart watch or smart clothing, a medical or eHealth device, a robot, industrial equipment, a drone, a vehicle such as a car, truck, train, or airplane, and the like.

The communications system 100 may also include a base station 114a and a base station 114b. Base stations 114a may be any type of device configured to wirelessly interface with at least one of the WTRUs 102a, 102b, and 102c to facilitate access to one or more communication networks, such as the core network 106/107/109, the Internet 110, and/or the other networks 112. Base stations 114b may be any type of device configured to wiredly and/or wirelessly interface with at least one of the RRHs (Remote Radio Heads) 118a, 118b, TRPs (Transmission and Reception Points) 119a, 119b, and/or RSUs (Roadside Units), 120a and 120b to facilitate access to one or more communication networks, such as the core network 106/107/109, the Internet 110, the other networks 112, and/or V2X server (or ProSe function and server) 113. RRHs 118a, 118b may be any type of device configured to wirelessly interface with at least one of the WTRU 102c, to facilitate access to one or more communication networks, such as the core network 106/107/109, the Internet 110, and/or the other networks 112. TRPs 119a and 119b may be any type of device configured to wirelessly interface with at least one of the WTRU 102d, to facilitate access to one or more communication networks, such as the core network 106/107/109, the Internet 110, and/or the other networks 112. RSUs 120a and 120b may be any type of device configured to wirelessly interface with at least one of the WTRU 102e or 102f, to facilitate access to one or more communication networks, such as the core network 106/107/109, the Internet 110, the other networks 112, and/or V2X server (or ProSe function and server) 113. By way of example, the base stations 114a and 114b may be a base transceiver station (BTS), a Node-B, an eNode B, a Home Node B, a Home eNode B, a site controller, an access point (AP), a wireless router, and the like. While the base stations 114a and 114b are each depicted as a single element, it will be appreciated that the base stations 114a and 114b may include any number of interconnected base stations and/or network elements.

The base station 114a may be part of the RAN 103/104/105, which may also include other base stations and/or network elements (not shown), such as a base station controller (BSC), a radio network controller (RNC), relay nodes, etc. The base station 114b may be part of the RAN 103b/104b/105b, which may also include other base stations and/or network elements (not shown), such as a base station controller (BSC), a radio network controller (RNC), relay nodes, etc. The base station 114a may be configured to transmit and/or receive wireless signals within a particular geographic region, which may be referred to as a cell (not shown). The base station 114b may be configured to transmit and/or receive wired and/or wireless signals within a particular geographic region, which may be referred to as a cell (not shown). The cell may further be divided into cell sectors. For example, the cell associated with the base station 114a may be divided into three sectors. Thus, in an embodiment, the base station 114a may include three transceivers, e.g., one for each sector of the cell. In an embodiment, the base station 114a may employ multiple-input multiple output (MIMO) technology and, therefore, may utilize multiple transceivers for each sector of the cell.

The base stations 114a may communicate with one or more of the WTRUs 102a, 102b, and 102c over an air interface 115/116/117, which may be any suitable wireless communication link (e.g., radio frequency (RF), microwave, infrared (IR), ultraviolet (UV), visible light, cmWave, mmWave, etc.). The air interface 115/116/117 may be established using any suitable radio access technology (RAT).

The base stations 114b may communicate with one or more of the RRHs 118a, 118b, TRPs 119a, 119b, and/or RSUs 120a and 120b, over a wired or air interface 115b/116b/117b, which may be any suitable wired (e.g., cable, optical fiber, etc.) or wireless communication link (e.g., radio frequency (RF), microwave, infrared (IR), ultraviolet (UV), visible light, cmWave, mmWave, etc.). The air interface 115b/116b/117b may be established using any suitable radio access technology (RAT).

The RRHs 118a, 118b, TRPs 119a, 119b and/or RSUs 120a, and 120b, may communicate with one or more of the WTRUs 102c, 102d, 102e, and 102f over an air interface 115c/116c/117c, which may be any suitable wireless communication link (e.g., radio frequency (RF), microwave, infrared (IR), ultraviolet (UV), visible light, cmWave, mmWave, etc.). The air interface 115c/116c/117c may be established using any suitable radio access technology (RAT).

The WTRUs 102a, 102b, 102c,102d, 102e, 102f, and/or 102g may communicate with one another over an air interface 115d/116d/117d (not shown in the figures), which may be any suitable wireless communication link (e.g., radio frequency (RF), microwave, infrared (IR), ultraviolet (UV), visible light, cmWave, mmWave, etc.). The air interface 115d/116d/117d may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 103/104/105 and the WTRUs 102a, 102b, 102c, or RRHs 118a, 118b, TRPs 119a, 119b and RSUs 120a, 120b, in the RAN 103b/104b/105b and the WTRUs 102c, 102d, 102e, and 102f may implement a radio technology such as Universal Mobile Telecommunications System (UMTS) Terrestrial Radio Access (UTRA), which may establish the air interface 115/116/117 or 115c/116c/117c respectively using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c, or RRHs 118a, 118b, TRPs 119a, 119b, and/or RSUs 120a, 120b, in the RAN 103b/104b/105b and the WTRUs 102c, and 102d may implement a radio technology such as Evolved UMTS Terrestrial Radio Access (E-UTRA), which may establish the air interface 115/116/117 or 115c/116c/117c respectively using Long Term Evolution (LTE) and/or LTE-Advanced (LTE-A). In the future, the air interface 115/116/117 may implement 3GPP NR technology. The LTE and LTE-A technology includes LTE D2D and V2X technologies and interface (such as Sidelink communications, etc.) The 3GPP NR technology includes NR V2X technologies and interface (such as Sidelink communications, etc.)

In an embodiment, the base station 114a in the RAN 103/104/105 and the WTRUs 102a, 102b, 102c, or RRHs 118a, 118b, TRPs 119a, 119b and/or RSUs 120a, 120b, in the RAN 103b/104b/105b and the WTRUs 102c, 102d, 102e, and 102f may implement radio technologies such as IEEE 802.16 (e.g., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114c in FIG. 16A may be a wireless router, Home Node B, Home eNode B, or access point, for example, and may utilize any suitable RAT for facilitating wireless connectivity in a localized area, such as a place of business, a home, a vehicle, a campus, and the like. In an embodiment, the base station 114c and the WTRUs 102e, may implement a radio technology such as IEEE 802.11 to establish a wireless local area network (WLAN). In an embodiment, the base station 114c and the WTRUs 102d, may implement a radio technology such as IEEE 802.15 to establish a wireless personal area network (WPAN). In yet another embodiment, the base station 114c and the WTRUs 102e, may utilize a cellular-based RAT (e.g., WCDMA, CDMA2000, GSM, LTE, LTE-A, etc.) to establish a picocell or femtocell. As shown in FIG. 16A, the base station 114b may have a direct connection to the Internet 110. Thus, the base station 114c may not be required to access the Internet 110 via the core network 106/107/109.

The RAN 103/104/105 and/or RAN 103b/104b/105b may be in communication with the core network 106/107/109, which may be any type of network configured to provide voice, data, applications, and/or voice over internet protocol (VoIP) services to one or more of the WTRUs 102a, 102b, 102c, and 102d. For example, the core network 106/107/109 may provide call control, billing services, mobile location-based services, pre-paid calling, Internet connectivity, video distribution, etc., and/or perform high-level security functions, such as user authentication.

Although not shown in FIG. 16A, it will be appreciated that the RAN 103/104/105 and/or RAN 103b/104b/105b and/or the core network 106/107/109 may be in direct or indirect communication with other RANs that employ the same RAT as the RAN 103/104/105 and/or RAN 103b/104b/105b or a different RAT. For example, in addition to being connected to the RAN 103/104/105 and/or RAN 103b/104b/105b, which may be utilizing an E-UTRA radio technology, the core network 106/107/109 may also be in communication with another RAN (not shown) employing a GSM radio technology.

The core network 106/107/109 may also serve as a gateway for the WTRUs 102a, 102b, 102c, 102d, and 102e to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and the internet protocol (IP) in the TCP/IP internet protocol suite. The networks 112 may include wired or wireless communications networks owned and/or operated by other service providers. For example, the networks 112 may include another core network connected to one or more RANs, which may employ the same RAT as the RAN 103/104/105 and/or RAN 103b/104b/105b or a different RAT.

Some or all of the WTRUs 102a, 102b, 102c, 102d in the communications system 100 may include multi-mode capabilities, e.g., the WTRUs 102a, 102b, 102c, 102d, and 102e may include multiple transceivers for communicating with different wireless networks over different wireless links. For example, the WTRU 102e shown in FIG. 16A may be configured to communicate with the base station 114a, which may employ a cellular-based radio technology, and with the base station 114c, which may employ an IEEE 802 radio technology.

FIG. 16B is a block diagram of an example apparatus or device configured for wireless communications in accordance with the embodiments illustrated herein, such as for example, a WTRU 102. As shown in FIG. 16B, the example WTRU 102 may include a processor 118, a transceiver 120, a transmit/receive element 122, a speaker/microphone 124, a keypad 126, a display/touchpad/indicators 128, a non-removable memory 130, removable memory 132, a power source 134, a global positioning system (GPS) chipset 136, and other peripherals 138. It will be appreciated that the WTRU 102 may include any sub-combination of the foregoing elements while remaining consistent with an embodiment. Also, embodiments contemplate that the base stations 114a and 114b, and/or the nodes that base stations 114a and 114b may represent, such as but not limited to transceiver station (BTS), a Node-B, a site controller, an access point (AP), a home node-B, an evolved home node-B (eNodeB), a home evolved node-B (HeNB), a home evolved node-B gateway, and proxy nodes, among others, may include some or all of the elements depicted in FIG. 16B and described herein.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 16B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 115/116/117. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet an embodiment, the transmit/receive element 122 may be configured to transmit and receive both RF and light signals. It will be appreciated that the transmit/receive element 122 may be configured to transmit and/or receive any combination of wireless signals.

In addition, although the transmit/receive element 122 is depicted in FIG. 16B as a single element, the WTRU 102 may include any number of transmit/receive elements 122. More specifically, the WTRU 102 may employ MIMO technology. Thus, in an embodiment, the WTRU 102 may include two or more transmit/receive elements 122 (e.g., multiple antennas) for transmitting and receiving wireless signals over the air interface 115/116/117.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as UTRA and IEEE 802.11, for example.

The processor 118 of the WTRU 102 may be coupled to, and may receive user input data from, the speaker/microphone 124, the keypad 126, and/or the display/touchpad/indicators 128 (e.g., a liquid crystal display (LCD) display unit or organic light-emitting diode (OLED) display unit). The processor 118 may also output user data to the speaker/microphone 124, the keypad 126, and/or the display/touchpad/indicators 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In an embodiment, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries, solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 115/116/117 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include various sensors such as an accelerometer, biometrics (e.g., finger print) sensors, an e-compass, a satellite transceiver, a digital camera (for photographs or video), a universal serial bus (USB) port or other interconnect interfaces, a vibration device, a television transceiver, a hands free headset, a Bluetooth® module, a frequency modulated (FM) radio unit, a digital music player, a media player, a video game player module, an Internet browser, and the like.

The WTRU 102 may be embodied in other apparatuses or devices, such as a sensor, consumer electronics, a wearable device such as a smart watch or smart clothing, a medical or eHealth device, a robot, industrial equipment, a drone, a vehicle such as a car, truck, train, or airplane. The WTRU 102 may connect to other components, modules, or systems of such apparatuses or devices via one or more interconnect interfaces, such as an interconnect interface that may comprise one of the peripherals 138.

FIG. 16C is a system diagram of the RAN 103 and the core network 106 according to an embodiment. As noted above, the RAN 103 may employ a UTRA radio technology to communicate with the WTRUs 102a, 102b, and 102c over the air interface 115. The RAN 103 may also be in communication with the core network 106. As shown in FIG. 16C, the RAN 103 may include Node-Bs 140a, 140b, and 140c, which may each include one or more transceivers for communicating with the WTRUs 102a, 102b, and 102c over the air interface 115. The Node-Bs 140a, 140b, and 140c may each be associated with a particular cell (not shown) within the RAN 103. The RAN 103 may also include RNCs 142a and 142b. It will be appreciated that the RAN 103 may include any number of Node-Bs and RNCs while remaining consistent with an embodiment.

As shown in FIG. 16C, the Node-Bs 140a, and 140b may be in communication with the RNC 142a. Additionally, the Node-B 140c may be in communication with the RNC 142b. The Node-Bs 140a, 140b, and 140c may communicate with the respective RNCs 142a and 142b via an Iub interface. The RNCs 142a and 142b may be in communication with one another via an Iur interface. Each of the RNCs 142a and 142b may be configured to control the respective Node-Bs 140a, 140b, and 140c to which it is connected. In addition, each of the RNCs 142a and 142b may be configured to carry out or support other functionality, such as outer loop power control, load control, admission control, packet scheduling, handover control, macro-diversity, security functions, data encryption, and the like.

The core network 106 shown in FIG. 16C may include a media gateway (MGW) 144, a mobile switching center (MSC) 146, a serving GPRS support node (SGSN) 148, and/or a gateway GPRS support node (GGSN) 150. While each of the foregoing elements are depicted as part of the core network 106, it will be appreciated that any one of these elements may be owned and/or operated by an entity other than the core network operator.

The RNC 142a in the RAN 103 may be connected to the MSC 146 in the core network 106 via an IuCS interface. The MSC 146 may be connected to the MGW 144. The MSC 146 and the MGW 144 may provide the WTRUs 102a, 102b, and 102c with access to circuit-switched networks, such as the PSTN 108, to facilitate communications between the WTRUs 102a, 102b, 102c and traditional land-line communications devices.

The RNC 142a in the RAN 103 may also be connected to the SGSN 148 in the core network 106 via an IuPS interface. The SGSN 148 may be connected to the GGSN 150. The SGSN 148 and the GGSN 150 may provide the WTRUs 102a, 102b, and 102c with access to packet-switched networks, such as the Internet 110, to facilitate communications between and the WTRUs 102a, 102b, 102c and IP-enabled devices.

As noted above, the core network 106 may also be connected to the networks 112, which may include other wired or wireless networks that are owned and/or operated by other service providers.

FIG. 16D is a system diagram of the RAN 104 and the core network 107 according to an embodiment. As noted above, the RAN 104 may employ an E-UTRA radio technology to communicate with the WTRUs 102a, 102b, and 102c over the air interface 116. The RAN 104 may also be in communication with the core network 107.

The RAN 104 may include eNode-Bs 160a, 160b, and 160c, though it will be appreciated that the RAN 104 may include any number of eNode-Bs while remaining consistent with an embodiment. The eNode-Bs 160a, 160b, and 160c may each include one or more transceivers for communicating with the WTRUs 102a, 102b, and 102c over the air interface 116. In an embodiment, the eNode-Bs 160a, 160b, and 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink and/or downlink, and the like. As shown in FIG. 16D, the eNode-Bs 160a, 160b, and 160c may communicate with one another over an X2 interface.

The core network 107 shown in FIG. 16D may include a mobility management gateway (MME) 162, a serving gateway 164, and a packet data network (PDN) gateway 166. While each of the foregoing elements are depicted as part of the core network 107, it will be appreciated that any one of these elements may be owned and/or operated by an entity other than the core network operator.

The MME 162 may be connected to each of the eNode-Bs 160a, 160b, and 160c in the RAN 104 via an Si interface and may serve as a control node. For example, the MME 162 may be responsible for authenticating users of the WTRUs 102a, 102b, and 102c, bearer activation/deactivation, selecting a particular serving gateway during an initial attach of the WTRUs 102a, 102b, 102c, and the like. The MME 162 may also provide a control plane function for switching between the RAN 104 and other RANs (not shown) that employ other radio technologies, such as GSM or WCDMA.

The serving gateway 164 may be connected to each of the eNode-Bs 160a, 160b, and 160c in the RAN 104 via the Si interface. The serving gateway 164 may generally route and forward user data packets to/from the WTRUs 102a, 102b, and 102c. The serving gateway 164 may also perform other functions, such as anchoring user planes during inter-eNode B handovers, triggering paging when downlink data is available for the WTRUs 102a, 102b, and 102c, managing and storing contexts of the WTRUs 102a, 102b, 102c, and the like.

The serving gateway 164 may also be connected to the PDN gateway 166, which may provide the WTRUs 102a, 102b, and 102c with access to packet-switched networks, such as the Internet 110, to facilitate communications between the WTRUs 102a, 102b, 102c and IP-enabled devices.

The core network 107 may facilitate communications with other networks. For example, the core network 107 may provide the WTRUs 102a, 102b, and 102c with access to circuit-switched networks, such as the PSTN 108, to facilitate communications between the WTRUs 102a, 102b, 102c and traditional land-line communications devices. For example, the core network 107 may include, or may communicate with, an IP gateway (e.g., an IP multimedia subsystem (IMS) server) that serves as an interface between the core network 107 and the PSTN 108. In addition, the core network 107 may provide the WTRUs 102a, 102b, and 102c with access to the networks 112, which may include other wired or wireless networks that are owned and/or operated by other service providers.

FIG. 16E is a system diagram of the RAN 105 and the core network 109 according to an embodiment. The RAN 105 may be an access service network (ASN) that employs IEEE 802.16 radio technology to communicate with the WTRUs 102a, 102b, and 102c over the air interface 117. As will be further discussed below, the communication links between the different functional entities of the WTRUs 102a, 102b, 102c, the RAN 105, and the core network 109 may be defined as reference points.

As shown in FIG. 16E, the RAN 105 may include base stations 180a, 180b, 180c, and an ASN gateway 182, though it will be appreciated that the RAN 105 may include any number of base stations and ASN gateways while remaining consistent with an embodiment. The base stations 180a, 180b, and 180c may each be associated with a particular cell in the RAN 105 and may include one or more transceivers for communicating with the WTRUs 102a, 102b, and 102c over the air interface 117. In an embodiment, the base stations 180a, 180b, 180c may implement MIMO technology. Thus, the base station 180a, for example, may use multiple antennas to transmit wireless signals to, and receive wireless signals from, the WTRU 102a. The base stations 180a, 180b, and 180c may also provide mobility management functions, such as handoff triggering, tunnel establishment, radio resource management, traffic classification, quality of service (QoS) policy enforcement, and the like. The ASN gateway 182 may serve as a traffic aggregation point and may be responsible for paging, caching of subscriber profiles, routing to the core network 109, and the like.

The air interface 117 between the WTRUs 102a, 102b, 102c and the RAN 105 may be defined as an R1 reference point that implements the IEEE 802.16 specification. In addition, each of the WTRUs 102a, 102b, and 102c may establish a logical interface (not shown) with the core network 109. The logical interface between the WTRUs 102a, 102b, 102c and the core network 109 may be defined as an R2 reference point, which may be used for authentication, authorization, IP host configuration management, and/or mobility management.

The communication link between each of the base stations 180a, 180b, and 180c may be defined as an R8 reference point that includes protocols for facilitating WTRU handovers and the transfer of data between base stations. The communication link between the base stations 180a, 180b, 180c and the ASN gateway 182 may be defined as an R6 reference point. The R6 reference point may include protocols for facilitating mobility management based on mobility events associated with each of the WTRUs 102a, 102b, and 102c.

As shown in FIG. 16E, the RAN 105 may be connected to the core network 109. The communication link between the RAN 105 and the core network 109 may defined as an R3 reference point that includes protocols for facilitating data transfer and mobility management capabilities, for example. The core network 109 may include a mobile IP home agent (MIP-HA) 184, an authentication, authorization, accounting (AAA) server 186, and a gateway 188. While each of the foregoing elements are depicted as part of the core network 109, it will be appreciated that any one of these elements may be owned and/or operated by an entity other than the core network operator.

The MIP-HA may be responsible for IP address management, and may enable the WTRUs 102a, 102b, and 102c to roam between different ASNs and/or different core networks. The MIP-HA 184 may provide the WTRUs 102a, 102b, and 102c with access to packet-switched networks, such as the Internet 110, to facilitate communications between the WTRUs 102a, 102b, 102c, and IP-enabled devices. The AAA server 186 may be responsible for user authentication and for supporting user services. The gateway 188 may facilitate interworking with other networks. For example, the gateway 188 may provide the WTRUs 102a, 102b, and 102c with access to circuit-switched networks, such as the PSTN 108, to facilitate communications between the WTRUs 102a, 102b, 102c and traditional land-line communications devices. In addition, the gateway 188 may provide the WTRUs 102a, 102b, and 102c with access to the networks 112, which may include other wired or wireless networks that are owned and/or operated by other service providers.

Although not shown in FIG. 16E, it will be appreciated that the RAN 105 may be connected to other ASNs and the core network 109 may be connected to other core networks. The communication link between the RAN 105 the other ASNs may be defined as an R4 reference point, which may include protocols for coordinating the mobility of the WTRUs 102a, 102b, and 102c between the RAN 105 and the other ASNs. The communication link between the core network 109 and the other core networks may be defined as an R5 reference, which may include protocols for facilitating interworking between home core networks and visited core networks.

The core network entities described herein and illustrated in FIGS. 16A, 16C, 16D, and 16E are identified by the names given to those entities in certain existing 3GPP specifications, but it is understood that in the future those entities and functionalities may be identified by other names and certain entities or functions may be combined in future specifications published by 3GPP, including future 3GPP NR specifications. Thus, the particular network entities and functionalities described and illustrated in FIGS. 16A-16E are provided by way of example only, and it is understood that the subject matter disclosed and claimed herein may be embodied or implemented in any similar communication system, whether presently defined or defined in the future.

FIG. 16F is a block diagram of an exemplary computing system 90 in which one or more apparatuses of the communications networks illustrated in FIGS. 16A, 16C, 16D, and 16E may be embodied, such as certain nodes or functional entities in the RAN 103/104/105, Core Network 106/107/109, PSTN 108, Internet 110, or Other Networks 112. Computing system 90 may comprise a computer or server and may be controlled primarily by computer readable instructions, which may be in the form of software, wherever, or by whatever means such software is stored or accessed. Such computer readable instructions may be executed within a processor 91 to cause computing system 90 to do work. The processor 91 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 91 may perform signal coding, data processing, power control, input/output processing, and/or any other functionality that enables the computing system 90 to operate in a communications network. Coprocessor 81 is an optional processor, distinct from main processor 91, that may perform additional functions or assist processor 91. Processor 91 and/or coprocessor 81 may receive, generate, and process data related to the methods and apparatuses disclosed herein.

In operation, processor 91 fetches, decodes, and executes instructions, and transfers information to and from other resources via the computing system's main data-transfer path, system bus 80. Such a system bus connects the components in computing system 90 and defines the medium for data exchange. System bus 80 typically includes data lines for sending data, address lines for sending addresses, and control lines for sending interrupts and for operating the system bus. An example of such a system bus 80 is the PCI (Peripheral Component Interconnect) bus.

Memories coupled to system bus 80 include random access memory (RAM) 82 and read only memory (ROM) 93. Such memories include circuitry that allows information to be stored and retrieved. ROMs 93 generally contain stored data that cannot easily be modified. Data stored in RAM 82 may be read or changed by processor 91 or other hardware devices. Access to RAM 82 and/or ROM 93 may be controlled by memory controller 92. Memory controller 92 may provide an address translation function that translates virtual addresses into physical addresses as instructions are executed. Memory controller 92 may also provide a memory protection function that isolates processes within the system and isolates system processes from user processes. Thus, a program running in a first mode may access only memory mapped by its own process virtual address space; it cannot access memory within another process's virtual address space unless memory sharing between the processes has been set up.

In addition, computing system 90 may contain peripherals controller 83 responsible for communicating instructions from processor 91 to peripherals, such as printer 94, keyboard 84, mouse 95, and disk drive 85.

Display 86, which is controlled by display controller 96, is used to display visual output generated by computing system 90. Such visual output may include text, graphics, animated graphics, and video. The visual output may be provided in the form of a graphical user interface (GUI). Display 86 may be implemented with a CRT-based video display, an LCD-based flat-panel display, gas plasma-based flat-panel display, or a touch-panel. Display controller 96 includes electronic components required to generate a video signal that is sent to display 86.

Further, computing system 90 may contain communication circuitry, such as for example a network adapter 97, that may be used to connect computing system 90 to an external communications network, such as the RAN 103/104/105, Core Network 106/107/109, PSTN 108, Internet 110, or Other Networks 112 of FIGS. 16A-16E, to enable the computing system 90 to communicate with other nodes or functional entities of those networks. The communication circuitry, alone or in combination with the processor 91, may be used to perform the transmitting and receiving steps of certain apparatuses, nodes, or functional entities described herein.

FIG. 16G illustrates one embodiment of an example communications system 111 in which the methods and apparatuses described and claimed herein may be embodied. As shown, the example communications system 111 may include wireless transmit/receive units (WTRUs) A, B, C, D, E, F, a base station, a V2X server, and a RSUs A and B, though it will be appreciated that the disclosed embodiments contemplate any number of WTRUs, base stations, networks, and/or network elements. One or several or all WTRUs A, B, C, D, and E can be out of range of the network (for example, in the figure out of the cell coverage boundary shown as the dash line). WTRUs A, B, C form a V2X group, among which WTRU A is the group lead and WTRUs B and C are group members. WTRUs A, B, C, D, E, and F may communicate over Uu interface or Sidelink (PC5) interface.

It is understood that any or all of the apparatuses, systems, methods and processes described herein may be embodied in the form of computer executable instructions (e.g., program code) stored on a computer-readable storage medium which instructions, when executed by a processor, such as processors 118 or 91, cause the processor to perform and/or implement the systems, methods and processes described herein. Specifically, any of the steps, operations or functions described herein may be implemented in the form of such computer executable instructions, executing on the processor of an apparatus or computing system configured for wireless and/or wired network communications. Computer readable storage media include volatile and nonvolatile, removable and non-removable media implemented in any non-transitory (e.g., tangible or physical) method or technology for storage of information, but such computer readable storage media do not include signals. Computer readable storage media include, but are not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other tangible or physical medium which may be used to store the desired information and which may be accessed by a computing system.

1-17. (canceled)

18. A wireless transmit/receive unit (WTRU) comprising at least one processor and memory storing instructions that, when executed by the at least one processor, cause the WTRU to:
determine a first resource allocation for a first mode of operation and a second resource allocation for second mode of operation, wherein in the first mode of operation, a network node schedules resources to be used by the WTRU for sidelink transmissions, and wherein in the second mode, the WTRU schedules resources to be used for sidelink transmission;
assign each of one or more logical channels a channel mode type, wherein the channel mode type indicates whether the logical channel is configured for use in the first mode of operation or the second mode of operation;
assign each of one or more grants a grant mode type, wherein the grant mode type indicates whether the grant is associated with the first mode of operation or the second mode of operation;
select, based on a channel mode type of a logical channel and a grant mode type of a grant, a destination;
select, based on the destination and the grant mode type of the grant, logical channels, of the one or more logical channels, to be transmitted over the grant; and
if a sidelink physical uplink control channel is configured, and sidelink feedback is received for a medium access control (MAC) protocol data unit (PDU) transmitted using the first resource allocation, signal a hybrid automatic repeat request (HARQ) to the network node.

19. The WTRU of claim 18, wherein the first mode of operation comprises 3GPP new radio sidelink resource allocation mode 1, and wherein the second mode of operation comprises 3GPP new radio sidelink resource allocation mode 2.

20. The WTRU of claim 18, wherein the network node comprises a base station.

21. The WTRU of claim 18, wherein the instructions further cause the WTRU to create a MAC PDU for the grant using logical channel restrictions.

22. The WTRU of claim 18, wherein each of the logical channels has an associated priority.

23. The WTRU of claim 18, wherein the instructions further cause the WTRU to:
select, from a plurality of grants associated with the first mode of operation and the second mode of operation that are overlapping or collided, a grant to use in a slot; and
send, to the network node, an indication when the selected grant is associated with the second mode of operation.

24. The WTRU of claim 18, wherein the WTRU is within a coverage area of the network node.

25. The WTRU of claim 18, wherein the WTRU is configured for operation in the first mode and the second mode via radio resource control (RRC) signaling.

26. A method comprising:
determining, by a wireless transmit/receive unit (WTRU), a first resource allocation for a first mode of operation and a second resource allocation for second mode of operation, wherein in the first mode of operation, a network node schedules resources to be used by the WTRU for sidelink transmissions, and wherein in the second mode, the WTRU schedules resources to be used for sidelink transmission;
assigning, by the WTRU, each of one or more logical channels a channel mode type, wherein the channel mode type indicates whether the logical channel is configured for use in the first mode of operation or the second mode of operation;
assigning, by the WTRU, each of one or more grants a grant mode type, wherein the grant mode type indicates whether the grant is associated with the first mode of operation or the second mode of operation;
selecting, by the WTRU and based on a channel mode type of a logical channel and a grant mode type of a grant, a destination;
selecting, by the WTRU and based on the destination and the grant mode type of the grant, logical channels, of the one or more logical channels, to be transmitted over the grant; and
if a sidelink physical uplink control channel is configured, and sidelink feedback is received for a medium access control (MAC) protocol data unit (PDU) transmitted using the first resource allocation, signaling, by the WTRU, a hybrid automatic repeat request (HARQ) to the network node.

27. The method of claim 26, wherein the first mode of operation comprises 3GPP new radio sidelink resource allocation mode 1, and wherein the second mode of operation comprises 3GPP new radio sidelink resource allocation mode 2.

28. The method of claim 26, wherein the network node comprises a base station.

29. The method of claim 26, wherein the instructions further cause the WTRU to create a MAC PDU for the grant using logical channel restrictions.

30. The method of claim 26, wherein each of the logical channels has an associated priority.

31. The method of claim 26, wherein the instructions further cause the WTRU to:
select, from a plurality of grants associated with the first mode of operation and the second mode of operation that are overlapping or collided, a grant to use in a slot; and
send, to the network node, an indication when the selected grant is associated with the second mode of operation.

32. The method of claim 26, wherein the WTRU is configured for operation in the first mode and the second mode via radio resource control (RRC) signaling.
